(19) United States
(12) Patent Application Publication
(10) Pub. No.: US 2025/0232322 A1
(43) Pub. Date: Jul. 17, 2025

(54) System for machine generated insights

(71) Applicant: PRINCIPAL FINANCIAL SERVICES, INC., Des Moines, IA (US)

(72) Inventors: Renee J. Batts, Ankeny, IA (US); Joel D. Bennett, Waukee, IA (US); Matthew J. Bartel, Buenos Aires (AR)

(73) Assignee: PRINCIPAL FINANCIAL SERVICES, INC., Des Moines, IA (US)

(21) Appl. No.: 19/025,340

(22) Filed: Jan. 16, 2025

Related U.S. Application Data
(60) Provisional application No. 63/621,402, filed on Jan. 16, 2024.

(51) Int. Cl. G06Q 30/0201; G06F 16/23

(52) U.S. Cl. CPC G06Q 30/0201; G06F 16/2365

(57) ABSTRACT

A system configured to extract, classify, and order entity insights may include a computing system, a computer readable memory, at least one processor having instruction configured for ingesting data into the system from at least one external application programming interface configured to retrieve data over a network, integrating the data to form a cohesive data set using the at least one processor, storing the cohesive data set into the computer readable memory, processing the cohesive data set by the at least one processor using at least one machine learning model to generate a plurality of entity insights, each of the insights having at least one classification associated therewith, ordering the plurality of the entity insights based on a machine generated prioritization, and generating a presentation comprising the plurality of entity insights in human-readable form.

### RELATED APPLICATIONS

This application claims priority to U.S. Provisional Patent Application No. 63/621,402, filed Jan. 16, 2024, hereby incorporated by reference In its entirety.

### TECHNICAL FIELD

The present disclosure relates to pipelines for machine learning. More specifically, but not exclusively, the present disclosure relates to a pipeline for machine generated insights and analytics using machine learning.

### BACKGROUND

One of the technical problems addressed by the pipeline and related methods and systems shown and described herein is the data silo problem. A data silo problem exists where data is isolated in separate databases or systems within an organization resulting in inefficiencies, lack of synergy, and difficulties in data management and analysis. Data silos result in a lack of integration as systems are not necessarily interconnected. Siloed data can lead to fragmented views of the organization's operations, customers, and market trends which impairs the ability to make informed, holistic decisions because the data required for comprehensive analysis is scattered across different silos. Data silos also create barriers to collaboration within an organization. It also prevents the organization from leveraging data analytics and business intelligence tools that require a comprehensive and integrated data set. In particular, it makes it difficult to identify what data should be used in various types of analyses.

Such problems are amplified if one is attempting to develop methods and systems which are workable for multiple organizations where each organization has its own problems and issues, and thus numerous technical issues arise with attempting to acquire and use data in meaningful ways.

Related technical problems relate to machine learning. Although machine learning is generally recognized as one approach to addressing a number of different problems there are many challenges to applying machine learning to business data. Examples of such problems include data quality and quantity. Data may be incomplete, inconsistent, or of poor quality. Inaccurate or biased data can result in unreliable or result in biased model predictions. Another problem relates to integration of machine learning models into existing machine processes and systems as doing so may require significant changes to current workflows and IT infrastructures. A further problem of applying machine learning models is the complexity and explainability as many models may generate results which are difficult to explain or understand. Numerous other problems are associated with machine learning including overfitting and generalization of training data such that machine learning models perform well on training data but poorly on new, unseen data.

Thus, there are numerous technical challenges and problems to overcome in identifying useful data within an organization which is of sufficient quality and completeness to support machine learning methodologies. There are further problems, in being able to standardize such data across multiple entities or organizations in order to increase the amount of training data availability to a point where it will support the training of a machine learning model or enhance the quality of the machine learning model to a point where it provides useful information for a diverse range of different inputs.

One particular area where such problems are particularly acute is in business analytics. Entities or organizations seeking business insights may be excluded from obtaining useful, reliable machine generated business insights for the above reasons and/or other technological challenges. Because they are unable to obtain or rely upon such insights they may fail to identify or believe actionable insights which may enhance efficiency, profitability, growth, or other business objectives.

A further problem with business analytics is that often such analysis is far from comprehensive and so only specific aspects of a business are analyzed in detail and so results are limited in scope. It may be that other aspects of the business are more important and so decisions may be made based on limited insights. An opposite problem may also be present in that business analytics, especially when machine generated may be large in number and may be contradictory in nature, thus there are difficulties in determining which insights might be most applicable or relevant as well as gaps between insights regarding issues and actions to address the issues.

Further problems relate to translating know-how, or experience associated with business analytics into a computer-implemented system. One approach is to generate a system of business logic in a linear fashion with known inputs and outputs at every stage. However, such an approach can be difficult if not impossible to provide a flexible system, particularly one which may be used in different business environments. Such difficulties further escalate the more comprehensive a system as the technology is not able to sufficiently simulate or model human reasoning to provide useful results. Thus, use of technology in business analytics often takes a very fragmented approach and is used to assist a human expert or support the findings of a human expert as opposed to being usable without expert guidance.

Such issues may be further amplified and multiplied for small businesses which may have very limited information technology infrastructures and use software and technologies on an ad hoc basis. Moreover, even where small businesses have some data, it may be a limited data set, given the small scale of the business and so meaningful insights may be difficult to obtain.

### SUMMARY

Therefore it is a primary object, feature, or advantage to improve over the state of the art.

It is a further object, feature, or advantage to develop a pipeline for ingesting data from a plurality of different entities or organizations in a standardized manner.

A further object, feature, or advantage is to apply machine learning methods to generate business insights.

A still further object, feature, or advantage is to generate business insights in a manner which is both data-driven and explainable to business owners or managers.

Another object, feature, or advantage is to identify accurate and complete data sufficient for use in machine learning models.

Yet another object, feature, or advantage is to present machine generating analysis in a manner in which users will recognize it as meaningful, useful, and/or reliable.

Another object, feature, or advantage is to provide a sufficiently comprehensive analysis about a business to be useful.

Yet another object, feature, or advantage is to provide insights across a plurality of different aspects of a business,

A still further object, feature, or advantage is to prioritize insights or actions based on insights.

Another object, feature, or advantage is to benchmark the performance of a business relative to other businesses such as those within the same industry, same region, and/or otherwise.

Yet another object, feature, or advantage is to provide a system which is flexible so that it may be applied to numerous different businesses.

Another object, feature, or advantage is to identify insights for business owners to use in growing their businesses.

Yet another object, feature, or advantage is to prioritize highest impact insights and determine delivery cadence/method.

A further object, feature, or advantage is to create perspective on insights through benchmarking.

A still further object, feature, or advantage is to Identify and create solution journeys.

Another object, feature, or advantage is to save insights and benchmarking for use in business scorecard and solution journeys.

Yet another object, feature, or advantage is to develop a clear communication path from review of the concierge.

A still further object, feature, or advantage is to share insights with concierges for all business owners.

Another object, feature, or advantage is to share insights to advisors for their business owners.

Yet another object, feature, or advantage is to identify, integrate, and manage a plurality of diverse data sources.

Another object, feature, or advantage is to leverage inherent accounting data relationships as validation mechanisms for machine learning models.

Yet another object, feature, or advantage is to utilize accounting data consistency requirements as ground truth for training machine learning models.

A further object, feature, or advantage is to employ natural relationships between different types of accounting reports as data validation tools.

A still further object, feature, or advantage is to implement a dynamic framework for selecting between rule-based, machine learning, and statistical analysis methods based on the type of business analysis required.

Another object, feature, or advantage is to provide a progressive insight generation pipeline that builds from validated financial data through operational patterns to strategic insights.

Yet another object, feature, or advantage is to maintain data reliability through multiple transformations from raw financial data to strategic insights.

A further object, feature, or advantage is to implement multiple contextual layers including industry benchmarks, regional comparisons, and size-based peer groups for insight generation.

A still further object, feature, or advantage is to provide a method for determining relevant contextual comparisons for specific business insights.

Another object, feature, or advantage is to implement a closed-loop system for validating the effectiveness of recommended business actions.

Yet another object, feature, or advantage is to provide an adaptive interface system that adjusts insight presentation based on user sophistication and business context.

A further object, feature, or advantage is to maintain quality validation chains from raw accounting data through pattern detection to insight generation.

A still further object, feature, or advantage is to implement feedback loops between action results and data quality assessment.

Another object, feature, or advantage is to provide a framework for matching insight presentation complexity to user context and sophistication.

Yet another object, feature, or advantage is to implement automated validation controls between pattern detection and raw accounting data.

A further object, feature, or advantage is to provide quality metrics for measuring insight generation reliability.

A still further object, feature, or advantage is to implement effectiveness measurement for recommended business actions.

One or more of these and/or other objects, features, or advantages will become apparent from the specification and claims that follow. No single embodiment need provide or include each and every object, feature, or advantage as different embodiments may have different objects, features, or advantages.

According to one aspect of this disclosure, a system is configured to extract, classify, and order entity insights. The system may include a computing system, a computer readable memory, at least one processor having instruction configured for ingesting data into the system from at least one external application programming interface configured to retrieve data over a network, integrating the data to form a cohesive data set using the at least one processor, storing the cohesive data set into the computer readable memory, processing the cohesive data set by the at least one processor using at least one machine learning model to generate a plurality of entity insights, each of the insights having at least one classification associated therewith, ordering the plurality of the entity insights based on a machine generated prioritization, and generating a presentation comprising the plurality of entity insights in human-readable form. The generation of a presentation may include generation of a dashboard display. The presentation of the data may include machine generated factual statements about the data. The presentation of the data may include contextual information to aid in understanding implications of the plurality of entity insights. The presentation of the data may include presentation of an external benchmark to demonstrate entity standing. The presentation may further include machine generated strategic goal associated with at least on the plurality of entity insights. The presentation may also include identification of a forum for meeting with others who have received related machine generated strategic goals and wherein the presentation further comprises the identification of the forum. The at least one machine learning model comprises a plurality of machine learning models to generate the plurality of entity insights. The plurality of machine learning models may include at least one large language model, at least one generative pre-trained transformer, at least one deep learning model, and/or at least one neural network.

According to another aspect, a system for machine generation of insights coupled with additional functionality is provided. The system includes at least one processor and a set of instructions for execution by the at least one processor, the set of instructions comprising a plurality of modules, each of the plurality of modules configured to analyze data to generate insights. The set of modules further includes a prioritization module configured to prioritize the insights. The set of modules further includes a presentation module configured to present the insights to a user. The plurality of modules may further include a benchmark module configured to provide benchmarks associated with a business, an action module for determining actions to perform based on the insights, and a scorecard module for providing ongoing feedback related to the actions and the insights.

According to another aspect, a system configured to extract, classify, and order entity insights is provided. The system includes a computing system, a computer readable memory, at least one processor, and a data integration architecture which includes an ingestion interface configured to receive data from disconnected data silos via at least one external application programming interface over a network, a data standardization module configured to map data fields from different source systems to a unified data model using standardized naming conventions and data formats, a data validation module configured to verify data quality and completeness for machine learning model compatibility, and an integration module configured to form a cohesive data set from the standardized data. The system may further include a multi-agent artificial intelligence framework which includes a data assessment agent configured to identify available data sources and accessible data fields, one or more data collection agents configured to retrieve and store identified data, one or more module insight agents configured to analyze data within specific business domains, a module intercommunication agent configured to facilitate analysis sharing between domain-specific agents, and an insight prioritization agent configured to evaluate and rank insights across domains. The at least one processor may be configured to: store the cohesive data set in the computer readable memory, execute the multi-agent artificial intelligence framework to: generate entity insights using the module insight agents, evaluate cross-domain relationships using the module intercommunication agent, prioritize the entity insights using the insight prioritization agent, and generate a presentation of the prioritized entity insights.

According to another aspect a system for generating machine learning-based business insights is provided. The system includes a data standardization subsystem configured to: establish secure API connections to one or more accounting software platforms, acquire standardized accounting data comprising at least profit and loss statements, general ledger entries, and customer transaction records, validate completeness and consistency of the accounting data through automated relationship verification between different accounting record types. The system further includes a machine learning pipeline configured to: identify reliable training data patterns from validated accounting record relationships, train a plurality of domain-specific machine learning models using the identified patterns, wherein the domain-specific models are configured to maintain consistency with accounting relationships while generating higher-level business insights, and combine rule-based business logic with the trained machine learning models to optimize computational efficiency while maintaining accuracy. The system further includes an insight generation subsystem configured to apply the trained domain-specific models to new accounting data in a staged approach. The initial stages analyze concrete financial relationships, intermediate stages identify business patterns derived from the financial relationships, and final stages generate strategic insights based on identified patterns. The insight generation subsystem further functions to validate generated insights against accounting data relationships to ensure consistency and prioritize insights based on quantifiable financial impact derived from the accounting data. The system further includes a presentation subsystem configured to generate visualizations that trace insights back to underlying accounting data relationships.

A system for validating machine learning training data using accounting relationships is provided. The system includes a data ingestion interface configured to receive accounting data from a plurality of accounting platforms. The system further includes an accounting relationship analyzer configured to identify standard accounting relationships within the received data, including double-entry constraints, report cross-references, and temporal dependencies, generate a validation ruleset based on the identified accounting relationships, and verify data consistency using the generated validation ruleset. The system further includes a machine learning validation subsystem configured to: use verified accounting relationships as ground truth for training data validation, maintain relationship graphs between different accounting data types and score data reliability based on adherence to accounting principles. The system further includes a model training module configured to: incorporate accounting relationship constraints into model training, adjust training weights based on data reliability scores, and validate model outputs against known accounting relationships. The system maintains data reliability through accounting relationship validation.

According to another aspect, a system for intelligent analysis selection in business data processing is provided. The system includes a data characterization module configured to: analyze input data characteristics including data type, volume, and quality, identify known business rules applicable to the input data, and determine data uncertainty levels. The system further includes an analysis selection engine configured to: maintain a registry of available analysis methods including rule-based systems, machine learning models, and statistical analyzers. The analysis selection engine is further configured to evaluate computational costs for each available analysis method and select optimal analysis methods based on data characteristics and computational costs. The system further includes a hybrid execution module configured to: coordinate execution of selected analysis methods, combine results from multiple analysis methods, and validate combined results against known business constraints. The system dynamically selects and combines analysis methods based on data characteristics and computational efficiency.

According to another aspect, a system for generating cross-domain business insights includes a progressive analysis pipeline configured to: validate financial data inputs using accounting relationships, identify operational patterns from validated financial data and generate strategic insights from operational patterns. The system further includes a domain relationship manager configured to: maintain mappings between financial, operational, and strategic domains, track insight dependencies across domains, and validate cross-domain consistency. The system further includes an insight generation engine configured to: apply domain-specific analysis models, identify relationships between insights from different domains, and maintain traceability between insights and source data. The system generates insights progressively while maintaining validation chains across domains.

According to another aspect a system is provided for determining contextual relevance in business analysis includes a context identification module configured to analyze business characteristics including industry, size, and location, identify applicable regulatory frameworks, and determine operational patterns. The system further includes a comparison framework configured to maintain contextual benchmarks for multiple business dimensions, identify relevant peer groups based on business characteristics, and generate multi-dimensional comparison metrics. The system further includes a relevance determination engine configured to score relevance of different contexts, select appropriate comparison frameworks, and adjust relevance weights based on business objectives. The system automatically determines and applies relevant business contexts for analysis.

According to another aspect a system is provided for converting business insights into validated actions. The system includes an action generation module configured to analyze business insights for actionability, identify required resources for implementation, and generate staged implementation plans. The system further includes a monitoring subsystem configured to track action implementation progress, measure impact of implemented actions, and validate effectiveness against predictions. The system further includes a feedback engine configured to analyze implementation results, update action recommendations based on measured effectiveness, and maintain action success metrics. The system provides closed-loop validation of insight-driven actions.

According to another aspect, a system for context-aware business insight presentation is provided. The system includes a user context analyzer configured to evaluate user technical sophistication, track user interaction patterns, and identify preferred information formats. The system further includes an insight adaptation engine configured to adjust presentation complexity based on user context, select appropriate visualization formats, and manage information density. The system further includes a presentation generator configured to create user-specific visualizations, provide progressive disclosure of details, and maintain consistent presentation frameworks. The system automatically adapts insight presentation based on user context and capabilities.

According to another aspect, a method for validating machine learning training data using accounting relationships includes steps of receiving accounting data from a plurality of accounting platforms, and analyzing the accounting data to identify standard accounting relationships by detecting double-entry relationships between accounts. The method further includes mapping cross-references between different financial reports, identifying temporal dependencies in transaction sequences, generating a validation ruleset from the identified accounting relationships. The method further includes validating machine learning training data by applying the validation ruleset to incoming data, scoring data reliability based on adherence to accounting principles, maintaining relationship graphs between different data types. The method further includes training machine learning models using the validated data by incorporating accounting relationship constraints into the training process. The method further includes adjusting training weights based on reliability scores, validating model outputs against known accounting relationships, and generating a validation report indicating reliability of the machine learning training data.

According to another aspect, a method for selecting and combining business data analysis approaches is provided. The method includes characterizing input data by analyzing data type, volume, and quality metrics, identifying applicable business rules, determining uncertainty levels in the data, evaluating available analysis methods by determining computational requirements for each method. The method further includes assessing method accuracy for the data characteristics, calculating expected processing time for each method, selecting optimal analysis methods based on data characteristics, computational costs, accuracy requirements, executing the selected analysis methods by coordinating parallel processing of different methods, combining results from multiple methods, validating combined results against business constraints, and generating an analysis report including results and validation metrics.

According to another aspect a method for generating cross-domain business insights includes establishing a progressive analysis sequence by validating initial financial data inputs, identifying operational patterns from financial data, deriving strategic insights from operational patterns, and maintaining cross-domain relationships by mapping connections between financial, operational, and strategic domains, tracking dependencies between insights across domains, validating consistency of cross-domain relationships. The method further includes generating insights through applying domain-specific analysis models, identifying relationships between insights from different domains, maintaining validation chains from source data to final insights, and producing an integrated insight report with cross-domain validations.

According to another aspect, a method for determining and applying business context in analysis is provided. The method includes analyzing business characteristics including identifying industry classification and subgroups, determining business size metrics, mapping geographical and regulatory contexts. The method further includes building comparison frameworks by collecting contextual benchmarks across business dimensions, identifying relevant peer groups, and generating multi-dimensional comparison metrics. The method further includes determining relevance weights by scoring importance of different contexts, calculating applicability of comparison frameworks, adjusting weights based on business objectives, applying contextual analysis to generate comparative insights, and producing a contextualized analysis report.

According to another aspect, a method for converting business insights into validated actions includes analyzing business insights for actionability by evaluating resource requirements, assessing implementation complexity, and determining prerequisite conditions. The method further includes generating implementation plans including creating staged execution sequences, defining success metrics, and establishing monitoring frameworks. The method further includes tracking implementation progress through monitoring execution status, measuring impact metrics, and validating effectiveness against predictions. The method further includes analyzing implementation results by comparing actual versus predicted outcomes, updating recommendation engines based on results, maintaining success rate metrics, and generating implementation effectiveness reports.

According to another aspect, a method for adapting business insight presentation to user context includes analyzing user context by evaluating technical sophistication levels, tracking interaction patterns, and identifying preferred information formats. The method further includes adapting insight presentation through adjusting complexity levels, selecting appropriate visualization formats, and managing information density. The method further includes generating user-specific presentations including creating context-appropriate visualizations, implementing progressive detail disclosure, and maintaining consistent presentation frameworks. The method further includes monitoring user interaction with presented insights and updating user context profiles based on interaction patterns.

According to another aspect, a system for generating validated machine learning insights includes a distributed computing system, a redundant computer readable memory system, and at least one processor having instructions configured to implement various subsystems. A data validation subsystem is configured to ingest data through secure API connections configured to retrieve accounting data over a network using standardized protocols, validate data consistency by verifying cross-reference integrity between related accounting entries, and detect and correct data anomalies using accounting relationship rules. A data integration engine is configured to map heterogeneous data sources to a standardized data model using automated field mapping, maintain data lineage tracking through the integration process, generate an integrated dataset with verified relationship integrity, and store the integrated dataset with indexing optimized for machine learning model access. A machine learning pipeline is configured to select appropriate machine learning models based on data characteristics and computational efficiency metrics, train models using accounting relationships as validation constraints, generate entity insights with confidence scores derived from data validation metrics, and maintain traceable connections between insights and source accounting data. A dynamic prioritization engine is configured to evaluate insight reliability using source data validation metrics, calculate insight priority scores using a multi-factor weighted algorithm, adjust prioritization weights based on computational feedback, and maintain consistency between related insights across business domains. An adaptive presentation generator is configured to select optimal visualization formats based on data characteristics, implement progressive data disclosure based on system resources, maintain real-time updates while optimizing computational efficiency, and generate interactive visualizations with validation trace-back capabilities.

According to another aspect, a system for generating validated machine learning insights includes a distributed computing system, computer readable memory, and at least one processor having instructions configured to implement. The system further includes a data validation subsystem configured to ingest data into the system through secure API connections configured to retrieve accounting data over a network using standardized protocols, validate data consistency by verifying cross-reference integrity between related accounting entries, and detect and correct data anomalies using accounting relationship rules. The system further includes a data integration engine configured to map heterogeneous data sources to a standardized data model using automated field mapping, maintain data lineage tracking through an integration process, generate an integrated dataset with verified relationship integrity, and store the integrated dataset with indexing optimized for machine learning model access. The system further includes a machine learning pipeline configured to select appropriate machine learning models based on data characteristics, train models using accounting relationships as validation constraints, generate entity insights with confidence scores derived from data validation metrics, maintain traceable connections between insights and source accounting data. The system further includes a dynamic prioritization engine configured to evaluate insight reliability using source data validation metrics, calculate insight priority scores using a multi-factor weighted algorithm, adjust prioritization weights based on computational feedback, and maintain consistency between related insights across business domains. The system further includes an adaptive presentation generator configured to select optimal visualization formats based on data characteristics, implement progressive data disclosure based on system resources, and generate interactive visualizations. The system may further include a benchmark module configured to provide benchmarks associated with a business, an action module for determining actions to perform based on the insights, and a scorecard module for providing ongoing feedback related to the actions and the insights. Each of the machine learning pipeline may be configured to analyze data to generate insights comprises a plurality of AI agents. The machine learning pipeline may implement a multi-agent artificial intelligence framework which includes a data assessment agent configured to identify and validate data sources; data collection agents configured to retrieve and validate accounting data; domain-specific insight agents configured to analyze validated data within business domains, a cross-domain validation agent configured to verify consistency between domain-specific insights, a prioritization agent configured to rank insights based on validation metrics, and a presentation agent configured to generate validated visualizations.

According to another aspect a system configured to extract, classify, and order entity insights includes a computing system, a computer readable memory, and at least one processor having instruction configured for: ingesting data into the system from at least one external application programming interface configured to retrieve data over a network, integrating the data to form a cohesive data set using the at least one processor, storing the cohesive data set into the computer readable memory, processing the cohesive data set by the at least one processor using at least one machine learning model to generate a plurality of entity insights, each of the insights having at least one classification associated therewith, ordering the plurality of the entity insights based on a machine generated prioritization, and generating a presentation comprising the plurality of entity insights in human-readable form. The cohesive data set may include validated accounting data maintaining double-entry accounting relationships between accounts. The integrating the data to form the cohesive data set may include steps of mapping data fields from different sources to a standardized data model, validating cross-reference integrity between related accounting entries, maintaining temporal dependencies between transactions, and tracking data lineage from source systems through transformations. The cohesive data set may maintain referential integrity between profit and loss statement entries, balance sheet entries, general ledger entries, journal entries, and transaction records. The cohesive data set may include validation metrics indicating quality and completeness of data integration.

### BRIEF DESCRIPTION OF THE DRAWINGS

FIG. 1 illustrates one example of a system or platform for providing machine generated insights.

FIG. 2 is one example of a method for performing machine generated insights.

FIG. 3 is a block diagram illustrating one example of a system or platform for providing machine-generated insights.

FIG. 4 further illustrates a pipeline for providing machine generated insights and context.

FIG. 5 is one example of a profit and loss statement such as may be provided through an API interface to a computer platform for use in generating machine generated insights.

FIG. 6 is one example of a journal such as may be provided through an API interface to a computer platform for use in generating machine generated insights.

FIG. 7 is an example of customer data such as may be provided through an API interface to a computer platform for use in generating machine generated insights.

FIG. 8 illustrates accounts receivable data such as may be provided through an API interface to a computer platform for use in generating machine generated insights.

FIG. 9 illustrates revenue data such as may be provided through an API interface to a computer platform for use in generating machine generated insights.

FIG. 10 illustrates a top client list such as may be provided through an API interface to a computer platform for use in generating machine generated insights.

FIG. 11 illustrates a GPO report such as may be generated to support one or more insights.

FIG. 12 illustrates an example of insights.

FIG. 13 illustrates an example of data which may be used by a classification or categorization module.

FIG. 14 illustrates examples of input into a computing platform.

FIG. 15 illustrates one example of a system where user AI agents are used.

FIG. 16 illustrates a further example of functionality of the computing platform 110 which may be implemented with additional modules.

FIG. 17 is one example of a graphical user interface for conveying insights to a user along with benchmarks and explanation.

FIG. 18 is one example of a graphical user interface for goal tracking.

FIG. 19 further illustrates a system or platform for providing machine generated insights.

FIG. 20 illustrates an example of a home page or landing page.

FIG. 21 illustrates an example of a user interface which allows for synchronization of data between a user's accounting system(s) and the system or platform.

FIG. 22 is a screen display for presenting insights to a user with cash flow insights being shown.

FIG. 23 is a screen display indicating recommendations for cash flow based on the cash flow insights.

FIG. 24 is a screen display illustrating additional information about the cash flow insight as well as a benchmark and supporting resources.

FIG. 25 is a screen display illustrating an aging receivables insight.

FIG. 26 is a screen display indicating recommendations and additional information for the aging receivable screenshot.

FIG. 27 is a screen display indicating a trailing 12 month revenue insight.

FIG. 28 is a screen display indicating recommendations and additional information for the trailing 12 month revenue insight.

FIG. 29 is a screen display indicating a client concentration insight.

FIG. 30A and FIG. 30B represent a screen display indicating recommendations and additional information for the client concentration insight.

FIG. 31 is a screen display indicating a churned customers insight.

FIG. 32A and FIG. 32B represent a screen display indicating recommendations and additional information for the churned customer insight.

FIG. 33 illustrates another implementation of a system for generating validated machine learning insights.

### DETAILED DESCRIPTION

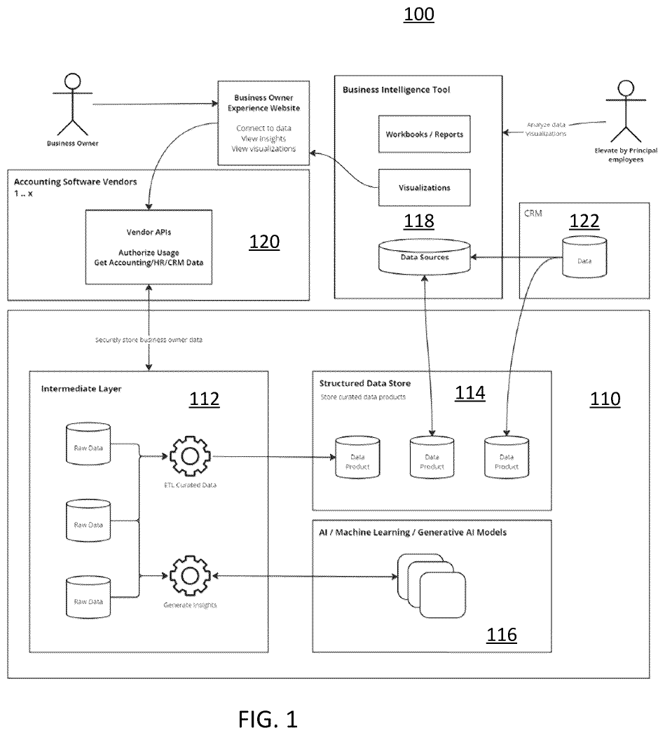

FIG. 1 illustrates one example of a system or platform for providing machine generated insights. The system or platform shown is one implementation as may be used in a particular use case. However, it is to be understood that what is shown is merely representative and numerous other implementations and use cases are contemplated as discussed herein. The system 100 includes a platform 110 which may include one or more computing systems or devices, and which may be used to provide insights or other aspects of the system. The platform 110 includes an intermediate layer 112 where data is collected from one or more sources and integrated to form an ETL curated data set which may be stored in a memory 114 which may be a collection of data stores. The intermediate layer 112 may also communicate with one or more AI, machine learning, or generative AI models 116 to generate insights.

The system also allows for data to be obtained from data or service providers 120 such as through appropriate APIs, reports, or otherwise. A business intelligence tool 118 is also shown as well as a client relationship management (CRM) platform 122 which includes additional data. The business intelligence tool 118 may be used to provide workbooks, reports, and visualizations such that insights or data in support of insights or action items based on insights may be delivered to a user such as a business owner.

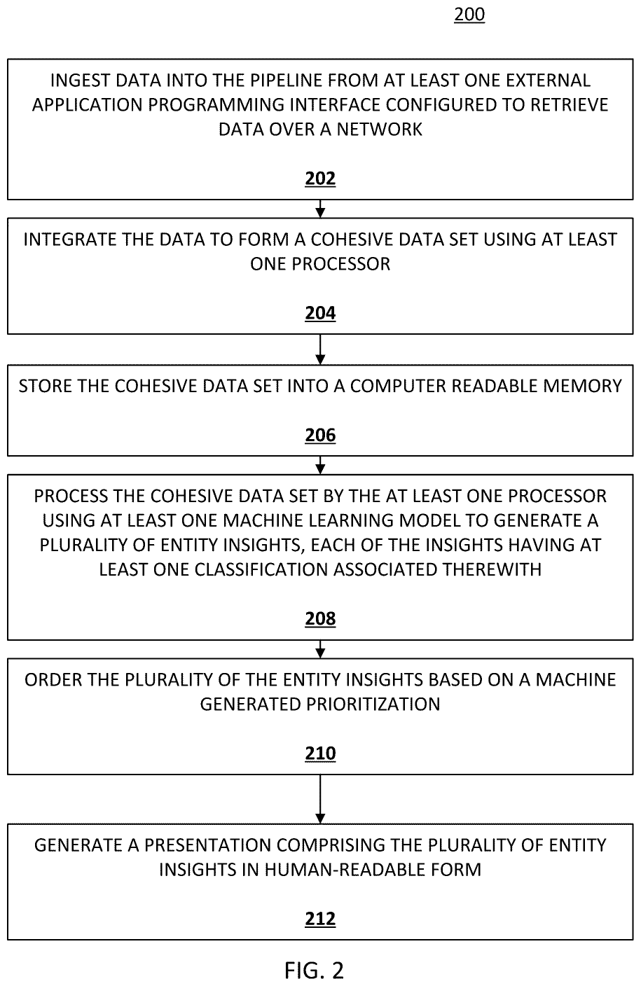

FIG. 2 is a flowchart of an example process 200 for generating machine insights. In some implementations, one or more process blocks of FIG. 2 may be performed by a system or platform which may include one or more computing devices or systems. As shown in FIG. 2, process 200 may include ingesting data into the pipeline from at least one external application programming interface configured to retrieve data over a network (block 202). For example, the system may ingest data into the pipeline from at least one external application programming interface configured to retrieve data over a network, as described above. As also shown in FIG. 2, process 200 may include integrating the data to form a cohesive data set using at least one processor (block 204). For example, the system may integrate the data to form a cohesive data set using at least one processor, as described above. As further shown in FIG. 2, process 200 may include storing the cohesive data set into a computer readable memory (block 206). For example, the system may store the cohesive data set into a computer readable memory, as described above.

The system creates and maintains a cohesive data set that preserves critical accounting relationships and data integrity. The cohesive data set is structured to maintain double-entry accounting relationships between accounts, ensuring that fundamental accounting principles are preserved through all data transformations. This preservation of accounting relationships serves as a foundation for reliable analysis and machine learning model training.

The integration process to form the cohesive data set may involve several technical steps. First, the system may map data fields from different source systems to a standardized data model. This mapping process may use predefined field mapping tables that maintain consistency across different accounting platforms and versions. The system then validates cross-reference integrity between related accounting entries, ensuring that relationships between different types of accounting records remain intact. Temporal dependencies between transactions may be maintained through timestamp preservation and transaction sequence validation. Throughout the integration process, the system may maintain detailed data lineage tracking, recording each transformation and validation step from the original source systems through to the final cohesive data set.

Within the cohesive data set, referential integrity may be maintained between different types of accounting records. This includes maintaining consistency between profit and loss statement entries, balance sheet entries, general ledger entries, journal entries, and transaction records. The system may implement referential constraints to ensure that relationships between these different record types remain valid and traceable. For example, when a journal entry affects the general ledger, the system may maintain bi-directional references between the journal entry and the corresponding general ledger entries. Similarly, when general ledger entries affect financial statements, these relationships may be preserved so that they may be traced in either direction.

The system may generate and maintain validation metrics for the cohesive data set to ensure data quality and completeness of integration. These metrics may include measurements of field population rates, relationship integrity scores, and data freshness indicators. The validation metrics may be updated whenever new data is integrated into the cohesive data set and may be used to assess the reliability of subsequent analysis and insights. For example, if certain relationships cannot be fully validated due to missing data, the system may adjust confidence scores for any insights derived from that portion of the data.

As also shown in FIG. 2, process 200 may include processing the cohesive data set by the at least one processor using at least one machine learning model to generate a plurality of entity insights, each of the insights having at least one classification associated therewith (block 208). For example, the system may process the cohesive data set by the at least one processor using at least one machine learning model to generate a plurality of entity insights, each of the insights having at least one classification associated therewith, as described above. As further shown in FIG. 2, process 200 may include ordering the plurality of the entity insights based on a machine generated prioritization (block 210). For example, the system may order the plurality of the entity insights based on a machine generated prioritization, as described above. As also shown in FIG. 2, process 200 may include generating a presentation having the plurality of entity insights in human-readable form (block 212). For example, the system may generate a presentation having the plurality of entity insights in human-readable form, as described above. The presentation may take the form of a dashboard display or a report. The presentation may include a scorecard, benchmarks, and other aspects.

Although FIG. 2 shows example blocks of process 200, in some implementations, process 200 may include additional blocks, fewer blocks, different blocks, or differently arranged blocks than those depicted in FIG. 2. Additionally, or alternatively, two or more of the blocks of process 200 may be performed in parallel.

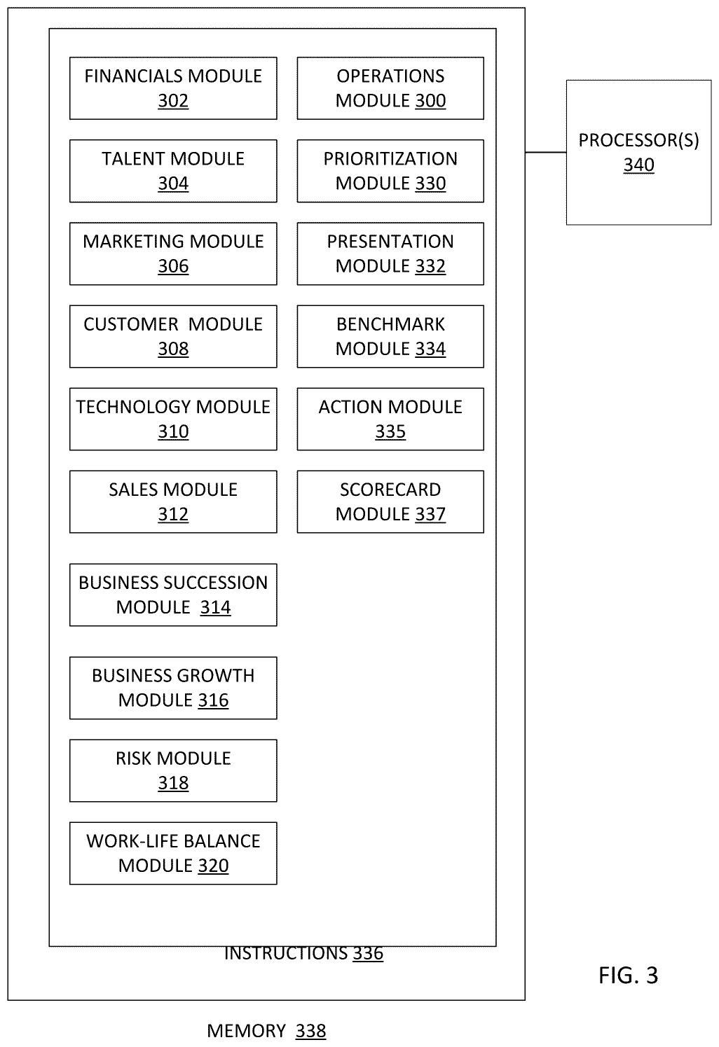

FIG. 3 is a block diagram illustrating one example of a system or platform for providing machine-generated insights. As shown in FIG. 3, memory 338 is shown in which a plurality of software instructions 336 are shown. At least one processor 340 is operatively connected to the memory 338 and configured to cause the instructions 336 to be executed.

As shown in FIG. 3, a modular approach is used where a plurality of different categories or classifications are shown including an operations module 300, a financials module 302, a talent module 304, a marketing module 306, a customer module 308, a technology module 310, a sales module 312, a business succession module 314, a business growth module 316, a risk module 318, and a work-life balance module 320. Each of these modules may be implemented in software and each of these modules may rely upon relevant data sources which may be different from other modules. Each of these modules may be configured to perform functions such as analyzing available data to generate insights, action items, or other information associated with the category or classification.

### Operations

One category or classification of insights relates to operations which may be associated with the operations module 300. Operations relates to procurement, process improvement, inventory and supplier management, project management, transportation, and logistics.

One insight related to operations is identifying spending and saving with group purchasing organizations (GPOs). The insight may identify existing or potential GPO relationships and identify where expense savings may be realized. The presentation may specifically show how much the entity is spending with the GPO, what they have purchased, and what they have saved.

Another insight might relate to business succession. Other types of insights related to operations include supplier management, inventory management, project management, and process management. Insights may relate to environment, social, and governance (ESG) systems and data. Other insights might relate to the relationships between contracting with customers and suppliers.

### Financials

Another category of insights relates to financial insights which may be associated with the financials module 302. This may include developing a financial model of the business and data from each type of financial report may be reviewed against financial models for insights. In some embodiments, the model may require additional data to augment its context. Such additional data may include, without limitation, tax information, regional data, external influences (such as inflation or political environment) to provide additional context associated with insights. Benchmarking may provide additional context, and action may be determined based on insights.

### Talent

Another category or classification relates to talent which may be associated with the talent module 304. Talent information may be obtained by industry and region including common roles, salaries, and organizational structure. Talent information for a particular entity may be compared against information for the industry or within a region. Analysis of attrition rates by role, salary level, and tenure may also be reviewed.

### Marketing

Another category or classification relates to marking which may be associated with the marketing module 306. Marketing can examine information about marketing overall spend, product spend, marketing tactics and campaign results. Marketing may review year-over-year spending to determine if investment remains steady.

Revenue for sources may be reviewed to determine if marketing campaigns are focused on higher value customers. Competitive analysis may also be performed based in information about competitors.

Data may be obtained and integrated from additional data sources including through the use of APIs including to obtain campaign information on social media campaigns, email campaigns, and other types of marketing campaigns.

### Customer

Another category or classification relates to customer information which may be associated with the customer module 308. For most businesses, customer retention is critical. This category or classification can produce insights based on analysis of conversations, feedback, and system activity to understand whether customers find value in the products and services as well as the usability experience.

In some embodiments data sources may include Hotjar or Google Analytics, or other analytics platforms to better understand customer experience associated with a web site or within a mobile app. Another data source may be customer experience management software (CXM) such as Medallia, Medallia Experience Cloud, Qualtrics CXM platform, Clarabridge, Delighted, AskNicely, or other platforms. Such software or platforms may provide surveys, feedback collection, sentiment analysis, reporting, and data analytics related to customer satisfaction, customer loyalty, and to make data-driven decisions to improve products and services. In some instances, relevant data may also be found in CRM tools or platforms.

Customer related data may be accessed through APIs, webhooks, imported from files, or otherwise.

### Technology

Another classification of insights relates to technology which may be associated with the technology module 310. It is noted that technological insights may be dependent on the type of business, industry, and the manner in which customer information is stored. In some embodiments technology insights may be provided from an interview or questionnaire based on business characteristics. This may include information about how customer data is stored, applicable privacy and security measures, internal security among employees as well as external investments in cyber security. Questions may further include information about technology infrastructure, who maintains technology, whether information is current or whether technology is supported by the manufacturer. In some embodiments, the interview may be performed using artificial intelligence such as through a chat agent or assistant which collects this information. Alternatively such information may be provided by a survey. Data may also be acquired through online platforms such as online platforms which provide computer security audits or compliance reports with the results provided via API, webhooks, or otherwise, or which produce reports.

### Sales

Another classification of insights relates to business sales. This may include efficacy of the sales team and the strategies implemented to acquire new business and this may be associated with the sales module 312. Insights can include analyzing sales and payroll data to determine if investment in individual salespeople are generating results, determining if the overall sales team is effective and yielding results, using a combination of marketing, sales, and customer acquisition results to determine if sales strategy is effective.

### Business Succession

Another classification of insights relates to business succession which includes planning for business succession and understanding how it may affect the financial wellness of a business owner. This functionality may be associated with the business succession module 314. Insight may include insights related to best practices and benchmarking for the business owners which best fit their business and situation. This may include types of tasks being completed, how the business owner has prepared for retirement, whether retirement plan is based on equity in the business, or whether there has been investing.

### Business Growth

Another classification of insights relates to business growth, and specifically change management work that is associated with growth as well as leadership and strategic planning. This may be associated with the business growth module 316. Growth may involve revenue growth, profit increases, reduced expenses, sales, marketing, and customer data which will show increased acquisition and retention, additional staffing, and operations which may show new processes or refined processes to manage scale. This may include identifying appropriate growth indicators, periodically reporting on the growth indicators, benchmarking.

### Risk

Another classification of insights relates to risk which may be associated with functionality of the risk module 318. This may include insights related to best practices to manage risk including business continuity practices, risk management and legal topics, disaster recovery planning, and SWOT analysis and end exercises which may be performed interactively.

### Work-Life Balance

Another classification or category of insights is the work-life balance of business owners. This may involve mental health, communication and collaborative tools, remote work. Functionality for obtaining these insights may be associated with the work-life balance module 320.

As previously explained, each of the modules may be configured to provide machine-generated insights, supporting data or analysis with its respective category. Additional modules may provide additional functionality. For example, a prioritization module 330 may be used to evaluate insights from different categories such as those from the operations module 300, the financials module 302, the talent module 304, the marketing module 306, the customer module 308, the technology module 310, the business succession module 314, the business growth module 316, the risk module 318, and the work-life balance module 320. The prioritization module 330 may then be used to determine the N most important insights from all the insights. The prioritization module 330 may do so by applying a machine learning model to the insights such as a neural network model, a CNN model, a statistical model, or other type of model. It is contemplated that there may be inter-relationships between the insights from different categories that would not be identified through human insight alone.

A benchmark module 334 is also shown. The benchmark module 334 may analyze different metrics for a business and provide a comparison to other businesses of interest, such as those within the same industry, providing the same type of products or services, within the same geographical region, or otherwise similarly situated in some manner.

An action module 335 is also shown which may be configured to provide action items or next steps based on the insights provided.

A scorecard module 337 is also shown which may be configured to monitor performance of a business regarding whether action items are implemented, or other steps taken and to monitor the effect of performing those action items or taking those steps over time.

A presentation module 332 is also shown. The presentation module 332 may determine and provide the insights, their prioritization, supporting information, and actions in a manner which is effective to a user. It is contemplated that different business owners may have different preferences, or may require different forms of presentation in order for the information to be conveyed effectively.

Although various modules have been shown and described, it is to be understood that more or fewer modules may be present. In addition, functionality of some modules may be combined as may be appropriate in a specific implementation.

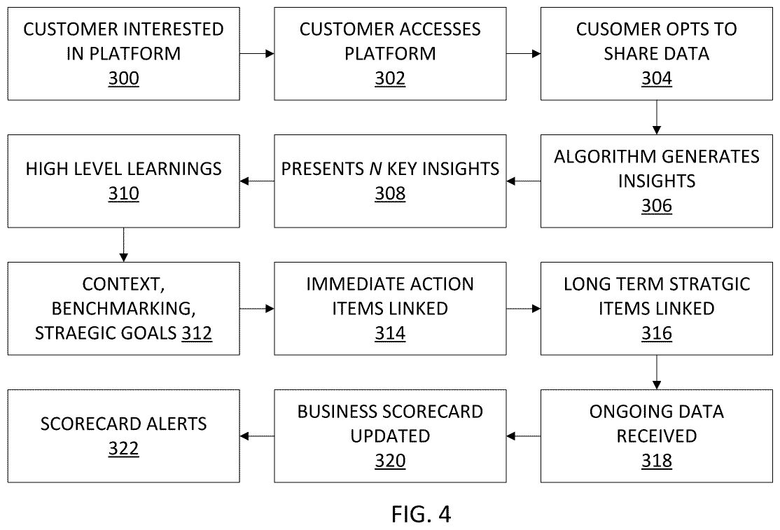

FIG. 4 further illustrates a method for providing machine generated insights and context. FIG. 4 is presented in context of an organization providing the services associated with the methodology and/or other services for a business. In step 300, a customer expresses interest in the platform 300. In step 302, the customer accesses the platform. In step 304, the customer opts to share data 304. For example, the customer may agree to make various types of data available through software services which they use. This may include making data available through API services which is advantageous as it allows for desired data to be provided in a manner which results in better transfer of data in an immediate and automated manner. Then in step 306, algorithms or models are applied to generate insights. The algorithm may include applying one or more machine learning model or AI models in order to obtain machine generated insights. In step 308, a plurality of key insights is presented. Although the specific number of insights may vary, three insights is a useful number. Where too many insights are presented, it can cause confusion, seem overwhelming, and not useful. Therefore, a small and manageable number is determined. It should be understood that insights are not necessarily indicative of weaknesses or problems associated with businesses. Sometimes, insights may recognize high performance or success and may acknowledge the driver for that performance to encourage that the high performance or success be acknowledged or maintained. In step 310, high level learnings may be determined. The high level learnings may indicate results of analysis performed. In step 312, context, benchmarking, or strategic goals may be generated based on results of analysis. In step 314, immediate action items may be linked to the insights and/or high-level learnings, and/or context, benchmarking, and strategic goals. In step 316, similarly, long term strategic items may be linked. In step 318, ongoing data may be received. In step 320, a business scorecard may be updated to show progress towards (or away) from action items and goals. In step 322, scorecard alerts may be communicated to users such as business owners to communicate progress as indicated by the business scorecard.

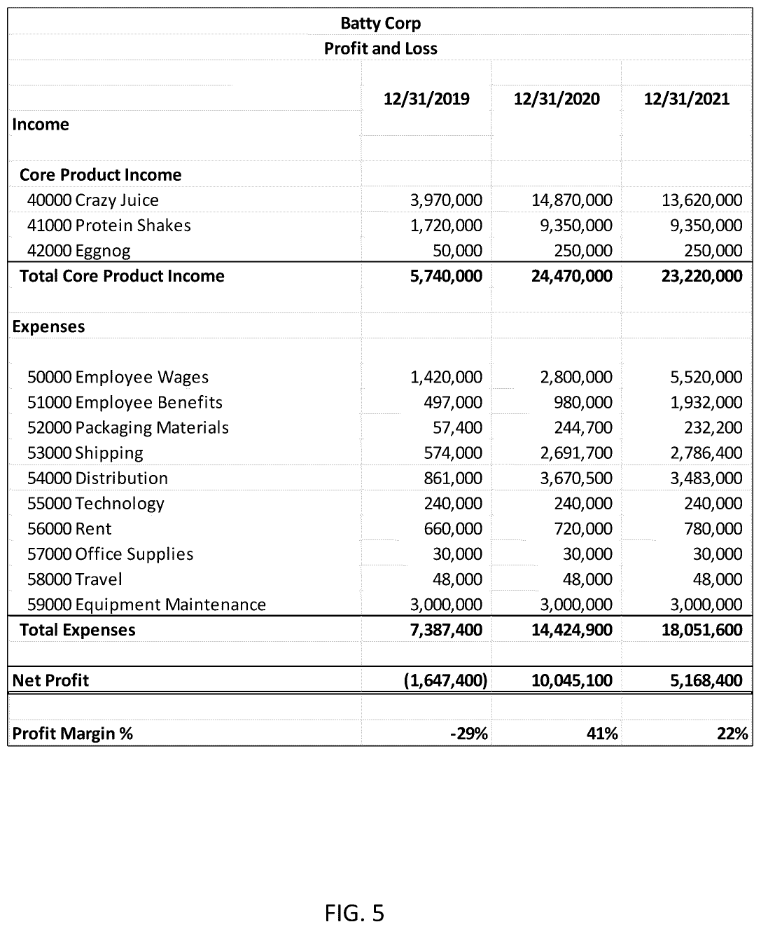

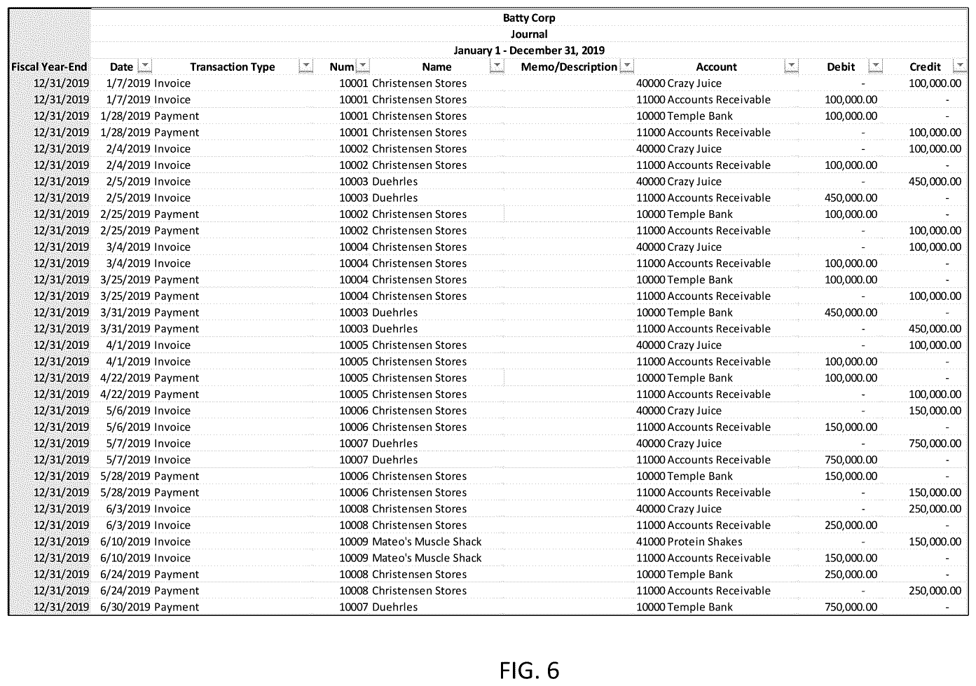

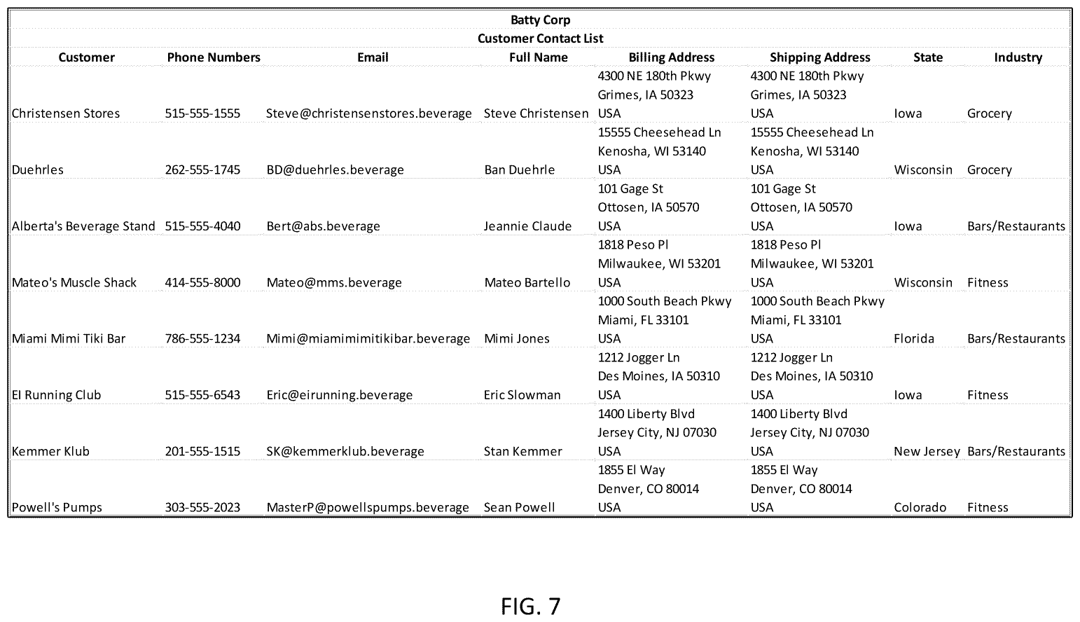

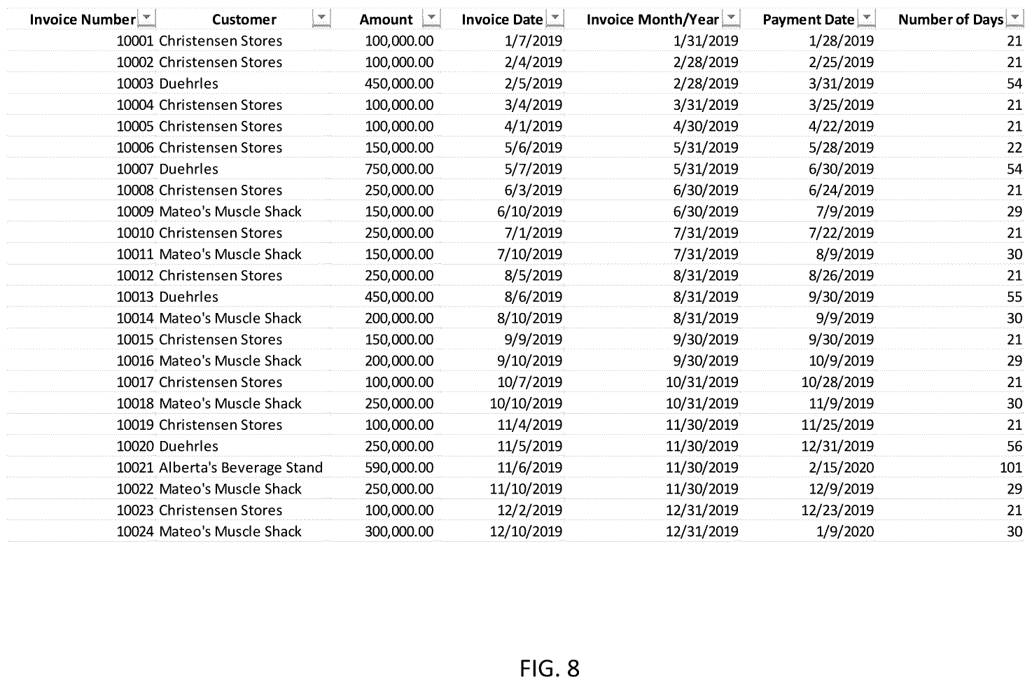

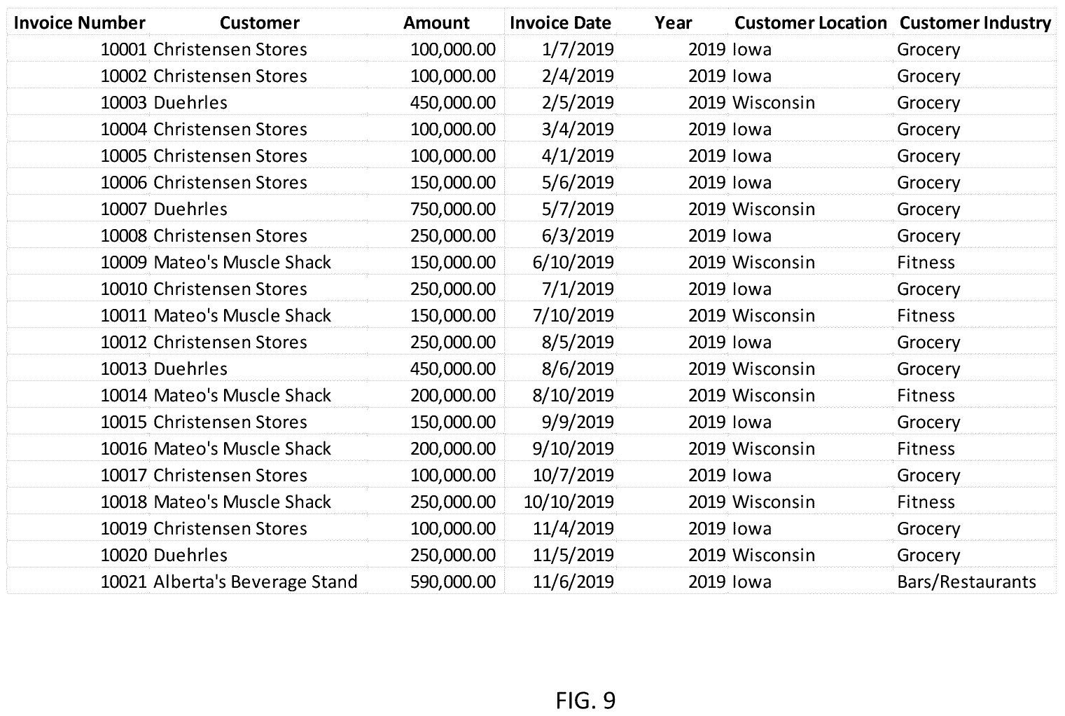

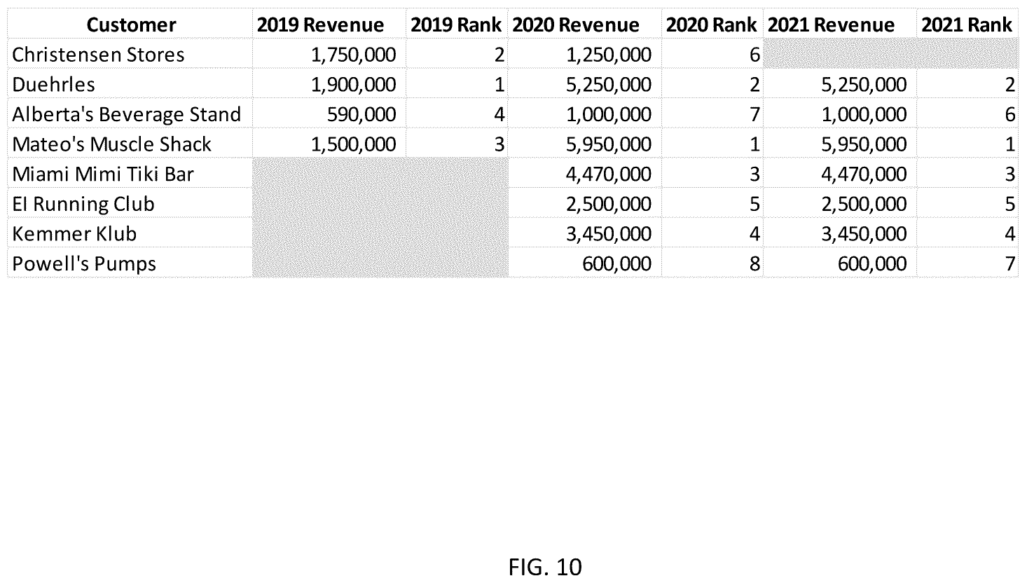

As previously explained, one example of a module is a financials module. The financials module may receive financials data. One way such data may be received is through an API from an accounting software vendor of a business. One popular accounting software platform is QuickBooks Online which provides an API. To support the analysis which leads to insights, various API calls may be made in order to provide relevant data. Alternatively, such data may be provided by automated reports, uploads or otherwise. FIG. 5 is one example of a profit and loss statement such as may be provided through an API interface to a computer platform for use in generating machine generated insights. FIG. 6 is one example of a journal such as may be provided through an API interface to a computer platform for use in generating machine generated insights. FIG. 7 is an example of customer data such as may be provided through an API interface to a computer platform for use in generating machine generated insights. FIG. 8 illustrates accounts receivable data such as may be provided through an API interface to a computer platform for use in generating machine generated insights. FIG. 9 illustrates revenue data such as may be provided through an API interface to a computer platform for use in generating machine generated insights. FIG. 10 illustrates a top client list such as may be provided through an API interface to a computer platform for use in generating machine generated insights. Alternatively, if a data such as shown in FIG. 10 is not available directly from the accounting software platform it may be generated from the underlying data by the platform.

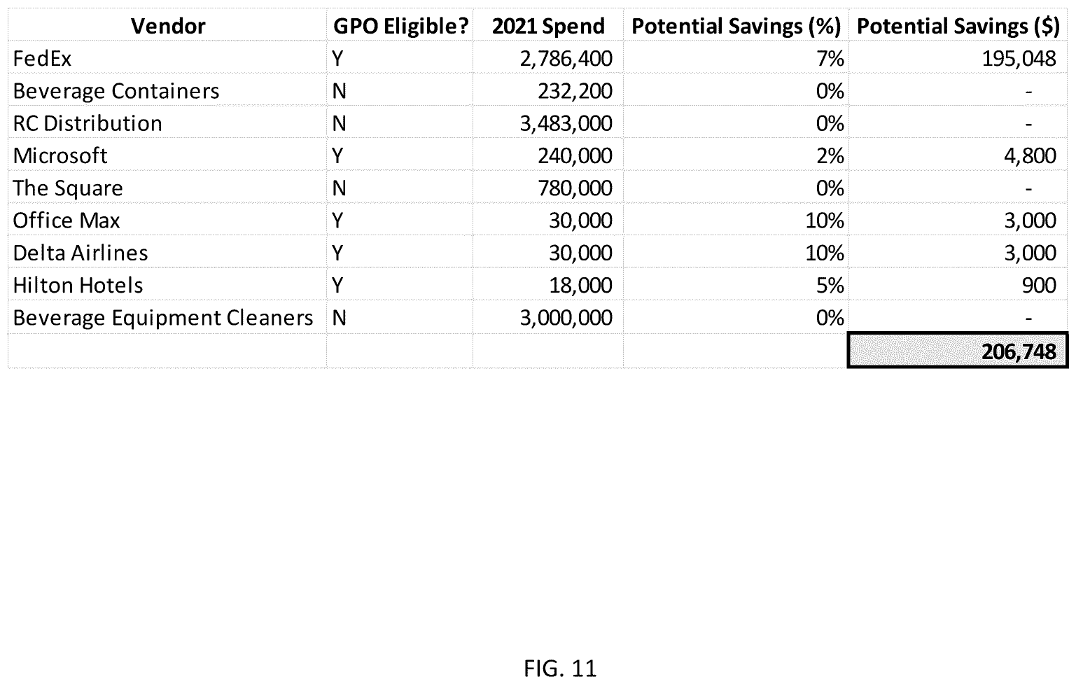

FIG. 11 illustrates a GPO report such as may be generated to support one or more insights. Such a report may be generated from an Operations module. For example, by reviewing a vendor list, the system may perform an analysis to identify which of the vendors are eligible through an existing GPO, the amount of spend provided for services from each vendor and a determination of potential savings for the business if the GPO was used. Note that in this example, both operations and financials may use some of the same underlying data.

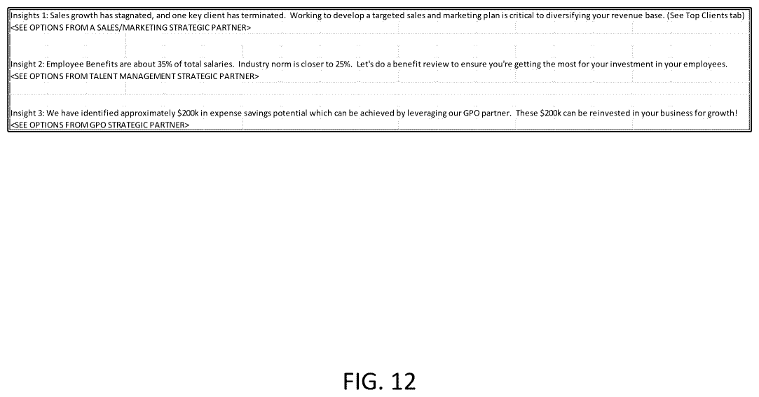

FIG. 12 illustrates an example of insights. In this example, data from FIG. 5 through FIG. 11 was used or generated and a number of insights were generated. Then from this list of insights, the insights were prioritized across categories to result in a limited number of specific insights, in this instance limited to three specific insights. The first insight is that sales growth has stagnated, and one key customer has terminated. This insight was determined at least in part from evaluating the top customers list and history. Returning to FIG. 10, note that one customer on this list of top customers was the second largest customer in 2019 and sixth largest in 2020, but was no longer a revenue-generating customer in 2021. In addition, there were four different top customers in 2020 (no revenue in 2019), but no new top customers in 2021. Moreover, in 2021, there was no growth in revenue for the top customers between 2020 and 2021. Thus, information from what is shown in FIG. 10, when properly interpreted supports the insight that sales growth has stagnated, and one key client has terminated. Based on this information and other information, then an action item may be to develop a targeted sales and marketing plan is critical to diversifying revenue base. A further item may be to engage a sales and marketing strategic partner and where such tools or services are available through the platform then those services can be provided.

The second insight shown in FIG. 12 is that employee benefits are about 35 percent of total sales, and the industry norm is closer to 25 percent, and it suggests performing a benefits review to ensure the business is getting the most from its investment in employees. Such an insight may be based on talent information, financial information, and other data. In addition to the review, there may be options for tools or services available through the platform or from a talent management strategic partner.

A third insight shown in FIG. 12 is the approximately $200 k in expense savings potential which can be achieved by leveraging a GPO partner. This insight is supported from the analysis shown in the GPO report of FIG. 11. This insight may be accompanied by options about the GPO strategic partner.

It should be understood that different businesses will have different insights, and the 3 most important insights may vary differently from business to business. It should also be understood, that determining what insights are present or how to prioritize insights is not a simple linear application of business logic translated to computing logic.

In some implementations, the platform may provide for forming and managing relationships between a business owner and advisors or concierges. Based on insights or action items, the platform may recommend particular advisors to work with the business. Analysis may be performed to match criteria associated with a business's needs to skills or experience of particular advisors. Advisors may include financial advisors, consultants, accountants, attorneys, and others. The platform may facilitate communications or initial communications between the advisors and business such that all can determine whether a relationship would be beneficial. Where a relationship is established, the advisor(s) may be provided access to relevant information associated with the platform according to the access rights approved by the business owner.

For example, in some embodiments, a prospective advisor may be provided information from the platform and hold an initial meeting with the business owner. If both parties agree to collaborate further then the platform can manage payment for services.

A concierge may be a knowledgeable and resourceful point of contact for businesses to address questions regarding the pipeline, platform, or other aspects. The concierge may assist in any number of different ways. For example, the concierge may communicate information regarding services offered by or through the platform which appear to fit a business's needs. In addition, a concierge may review analysis, including insights, prior to sharing with business owners to ensure quality of analysis, identify outliers, or edge use cases which may require further refinement of AI models. In addition, the concierge may provide for managing relationships such as by specifying the manner in which results of analysis should be presented.

In some implementations, certain advisors and concierges may be implemented in software such as AI assistants or agents. Such AI advisors may be a part of third party services or a part of a platform. Where third parties are providing advisors or other resources, the platform may provide for managing payment from businesses to the advisors or otherwise participate in managing the relationship.

It is further contemplated that other types of resources may be provided. This may include memberships in forums associated with similarly situated business owners or other business owners with similar goals. It may further include subscriptions to relevant reading material, audio courses, or video courses, or other information. It may include recommendations for using particular products or services which may assist a business owner in meeting strategic objectives in the short-term and/or long-term.

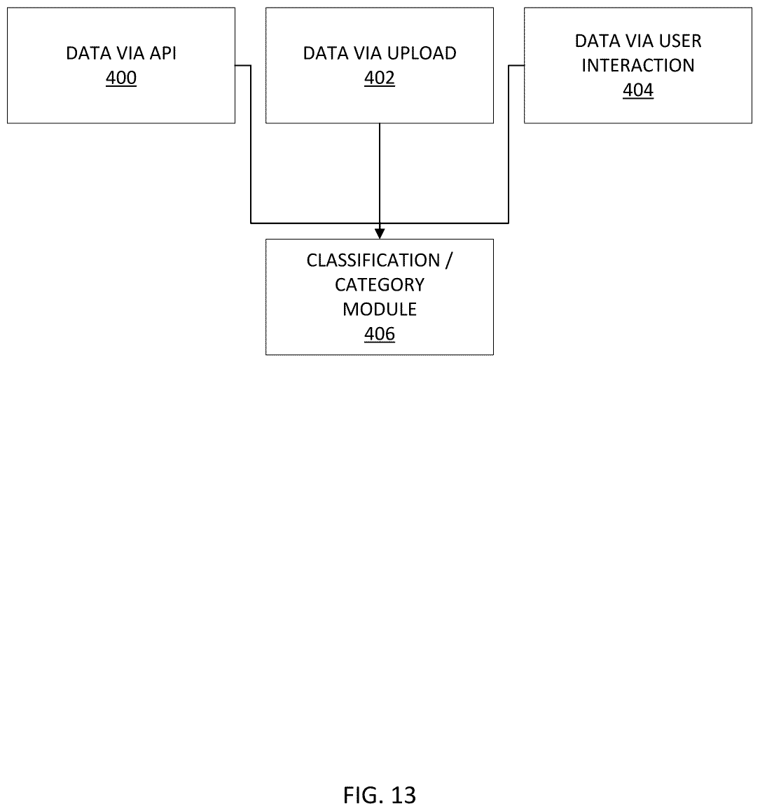

FIG. 13 illustrates examples of input into a computing platform and inputs which may be received. For any classification or category module such as those shown in FIG. 3, different types of input may be provided in different ways. For example, in block 400, data may be provided via API. Alternatively, data may be provided by upload in block 402. Alternatively, in some aspects data may be provided via user interaction according to block 404. The user interaction may be in the form or requiring a survey or online form to be provided, or for the user to engage with an interactive AI chat or to otherwise receive user interaction. Such data may be received by the classification or category module 402 which may then perform appropriate analysis including through the use of machine learning or AI models.

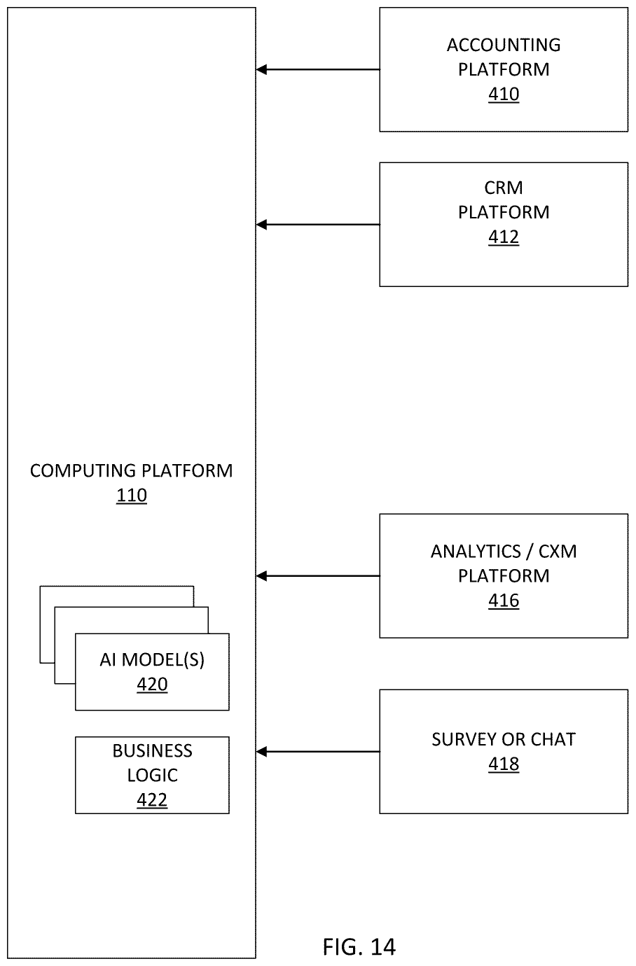

FIG. 14 illustrates the computing platform 110 is shown which may have any number of different inputs depending upon the categories and the available data. Examples may include an accounting platform 410, a CRM platform 412, an analytics and/or CXM platform 416, survey or chat interaction 418. Thus, the computing platforms and the models used may use available data from connected sources of data associated with a business. This is advantageous as where data comes from the same sources, there is less variation in the structure of the data, collection of data can be automated once access has been granted, and thus a great deal of data can be used in applying appropriate models or frameworks in order to obtain the desired analysis including insights.

The computing platform 110 may be implemented using any number of computing devices, computing services, processors, and hardware and/or software components. The computing platform 110 may include any number of different AI models 420. It is contemplated that different modules may each have their own models; different data sources may have their own different models. It should be understood that any single module or data source may use one or more different AI models. It is also to be understood that AI models 420 may be combined with business logic 422 in order to increase computational efficiency or improve performance.

The data such as shown in FIG. 14 whether obtained via API, data upload, or otherwise may be ingested by the computing platform as a part of a data ingestion process. As previously mentioned, data availability and data quality can be significant problems to implementing machine learning methods as such data issues can result in a poorly trained model or poor results from application of a model. Therefore, models have been generated which use accounting data and especially accounting data acquired directly from accounting software platforms. Accounting data is usually higher quality data with more reliability than other types of data. In addition, there are multiple and complex relationships between different items of accounting data such as data from different types of reports, which would not generally be recognized or understood by humans, even those skilled in finance or accounting.

Of particular interest are reports such as a customer list, vendor list, balance sheet, profit and loss, general ledger, journal, and statement of cashflow. These may further include a client count showing accumulation of customers over time, a client geographic concentration, a client industry concentration, a growth rate (preferably for each product and service), profit (showing gross and net profit margins for each product), a GPO direct match list showing a list of vendors who are a direct match with vendors in a GPO agreement and preferably the spend with each vendor on an annual, quarterly, or monthly basis, and a chart showing the top spend on vendors. Preferably, such reports are accessible through an application programming interface (API). Thus, a computing platform with proper authorization may access such reports through an API. One example of an account software platform with such an API is QuickBooks Online API. Other examples of accounting software platforms with APIs include, without limitation, Xero, Sage, FreshBooks, Zoho Books, Wave, Oracle NetSuite, Intacct, and others. It is contemplated that not all information may be available from all sources. In some instances some of this information may be obtained through analysis of available information if the accounting software platform does not provide the functionality.

Each of these accounting software platforms may have an API such as a web-based (Representational State Transfer) REST API. Each of these accounting software platforms may have different endpoints for operations such as Create, Read, Update, and Delete (CRUD operations). It is contemplated that in some embodiments only the Read operations are needed. However, in some embodiments other types of CRUD operations may be performed.

The APIs may use any number of data formats and protocols. For example JSON (JavaScript Object Notation) may be used for data exchange with requests to the API and responses from the API being in JSON according to RESTful principles. The APIs may support one or more authentication protocols. One such example is OAuth 2.0 Authentication. Some APIs may support querying using Structured Query Language (SQL) like syntax to perform operations such as retrieving and filtering data.

Utilizing data from accounting platforms through APIs allows data to be regularly updated so that additional analysis or insights may be obtained at any time. In some embodiments the APIs may support webhooks allowing applications to receive real-time notifications about changes which may indicate that additional actions should be taken such as to ingest additional data to generated updated or additional insights. In addition, progress towards strategic objectives based on prior insights may be monitored and quantified.

Furthermore, data may be standardized from different accounting sources based on the type of reports. For example, data may be mapped from each accounting software sources to a unified data model which includes all necessary fields and reports and preferably uses standard naming conventions, data types, and formats. Data acquired through the API may be extracted and then transformed and may be stored in a database, data warehouse, or data lake. Such steps may be performed using Extract, Transform, Load (ETL) tools for automation.

Examples of accounting data and reports which may be communicated through APIs or otherwise include a profit and loss statement, journal data, customer data, accounts receivable data, revenue data, top client data as previously explained.

The machine-generated insights described herein include expert learnings and observations that will enable a business owner to make changes that positively impact their ability to grow their business. The machine-generated insights may, for example, be presented as factual statements about the data expressed as an opportunity to improve or celebration of work well done. It is accompanied by contextual information to aid in understanding the insight's implications to the business; an external benchmark to demonstrate the business' standing in contrast with others in their industry, size or revenue range; a strategic goal to implement for improvement of the insight; related content; actionable recommendations and a place to meet with others in a forum who have similar work before them.

As shown in FIG. 14, one or more AI models 420 may be used. Various methods of model selection and training may be used. Based on data acquired, including accounting data from one or more platforms and after standardization of the data such as previously described, insights may be generated to serve as training outputs for the data. In some embodiments, it is contemplated that in order to provide training data, experts may study the data to identify learnings and observations or other insights. For example, insights may be initially created through the business acumen of a subject matter expert (SME) for each particular set of data generated. Data includes, but is not limited to business owner, financials; talent and human resources; sales; marketing; customer; inventory management; project and process management; business succession planning; risk and work-life balance. This may involve a number of different experts. In some respects, AI models may be used to generate dummy data based on insights and then the dummy data may be used as training data. It is contemplated that numerous methods may be used, and methods may be transitioned through an ongoing process. For example, initially a small set of human-compiled business data and insights may be used in a model which supports one-shot or few-shot learning to refine data or to generate a model which can be used to generate additional training data. The more the models are used and the more data that becomes available, the more refinement of different models may occur leading to increasingly improved results.

One type of generative AI model which may be used are large language models. Examples of Large Language Models (LLMs) include, without limitation, GPT-4, GPT-40 from OpenAI, Gemini from Google, Claude from Anthropic, Cohere from Cohere, Jurassic-1 from AI21 Labs, Inflection-1 from Inflection AI, Alpaca from Stanford, BLOOM from Hugging Face, BLOOMChat from SambaNova, Cerebras-GPT from Cerebras, Dolly from Databricks, Falcon from TII, FastChat from LMSYS, FLAN-T5 from Google, FLAN-UL2 from Google, GPT-J from EleutherAI, GPT4AII from Nomic AI, GPTNeo from EleutherAI and Together, Guanaco from UW NLP, and Koala from BAIR. Any number of currently known or future LLMs or other AI models may be used.

Where generative AI is used, it is contemplated that it may be combined with other technologies including, without limitation, rule-based systems, retrieval-based models, contextual models, multimodal models, as may be appropriate in a particular implementation, such as to reduce costs, increase performance, reduce processor resources, reduce processing time, or otherwise.

It is further contemplated that some models may be pre-trained on relevant data. Alternatively or in addition, a model may be fine-tuned for a specific task with labeled data. For example, in some embodiments each category or classification of insight may use its own fine-tuned model to provide insight relevant to that classification. Or alternatively a model may be fine-tuned to perform a plurality of tasks associated with different classifications of insights. Thus, for example, the same model, such as GPT-4 may be fine-tuned for performing each specific task, or a plurality of different tasks.

According to another aspect, the analysis may be performed in whole or in part using a collection of agents and interactions between agents to provide the insights or additional functionality. For example, each category of insights may have one or more agents as a part of the workflow or pipeline.

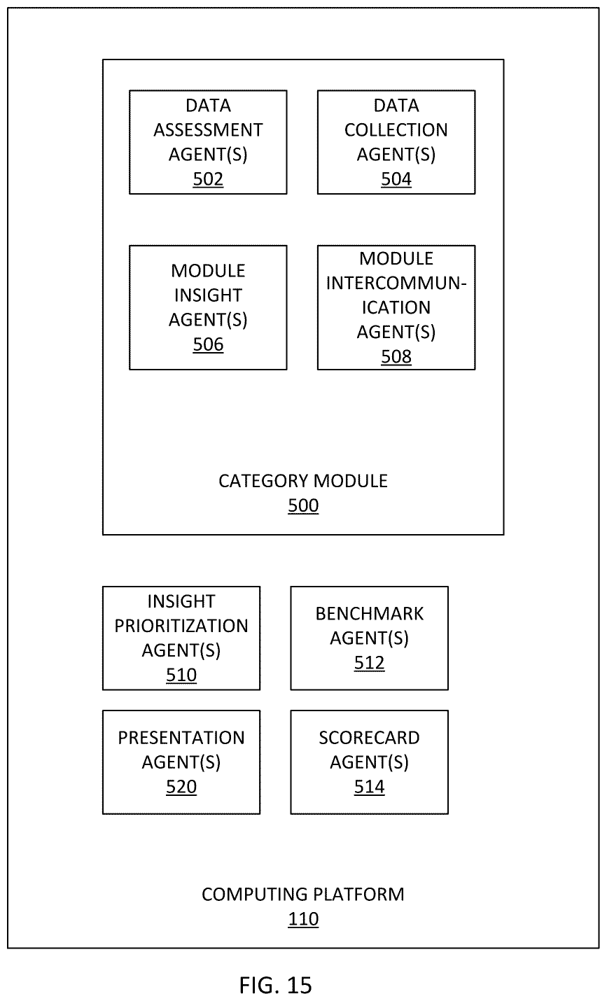

FIG. 15 illustrates one example of a category module 500 where multiple AI agents are used such as may be implemented using the Microsoft Autogen framework. A set of agents may be defined for each category. Each of the specialized agents may have specialized capabilities and roles and the interaction behavior between the agents may be defined according to the functionalities required for the module. For example, a data assessment agent 502 may be defined to determine what sources of information relevant to a module are available, such as what data sources are connected and what data can be provided from each of the data sources. Such an agent may be configured to identify data sources connected via API and what data might be available otherwise. One or more data collection agents 504 may be configured to actually retrieve the data to either save in a data store or from the data store. A module insight agent 506 may provide insights for the current category. A module intercommunication may be configured to communicate with other modules to collect data or analysis from other modules. An insight prioritization agent 510 may be configured to prioritize insights generated by one or more module insight agent(s) 506. A benchmark agent 512 may be configured to generate a benchmark for each category. A scorecard agent 514 may be configured to generate a scorecard for a business. The business scorecard may be one form of visualization and may include insights from the different categories of insights. The scorecard may provide visualizations of financials, business processes, customers, and organizational capacity relative to goals or action items. Alerts may be provided for thresholds that are met or missed. Thus, each category may have one or more associated agents. In addition, the computing platform 110 may include agents for each category as well as additional agents such as a presentation agent 520 or other types of agent.

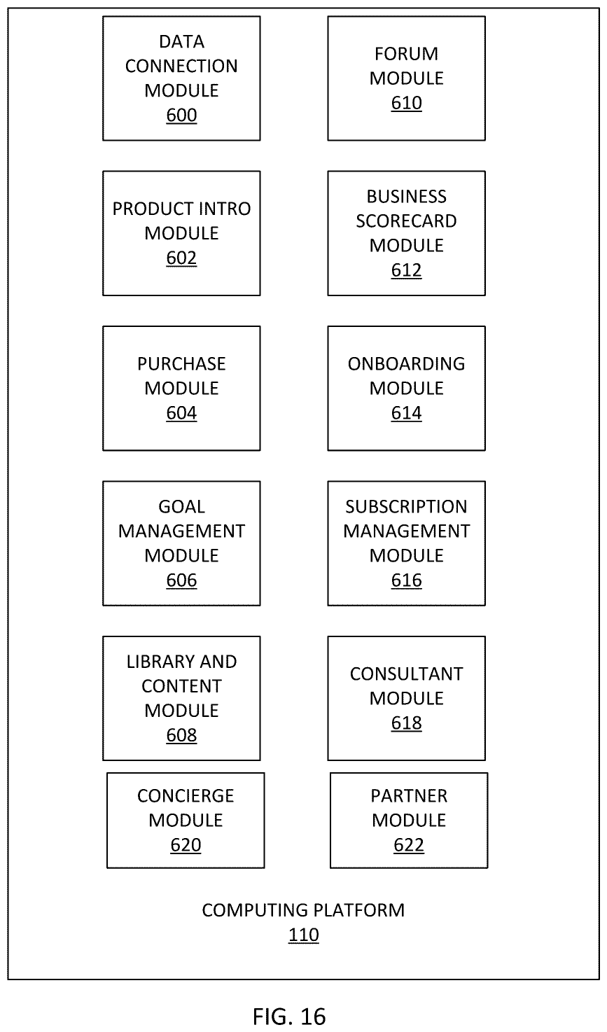

FIG. 16 illustrates that the computing platform 110 may include additional modules to provide additional functionality. A data connection module 600 is shown which may be used to manage data source connections and well as receiving data from other sources. A product intro module 602 is shown which may be used in various ways. It is contemplated that a curated collection of a number of products or services of potential benefit to a business owner may be maintained. This may include product information including information about a strategic partner who offers the product (e.g., product, service, or system) which may be available to the business owner when an insight guides them toward a solution that can be purchased. The product intro module may perform solution analysis on all insights and where appropriate link to information about a product and strategic partner. This may include information about what the product is/does, the process for onboarding and the approximate cost. The product intro module may allow the business owner to save the information for future reference. Specific purchase paths may be designed.

A purchase module 604 is also shown. It is contemplated that payment information may be stored and collected for various aspects of the surface including products which are recommended and then purchased through the platform 110, payments to advisers or consultants, payments for subscription products, or other tools.

A goal management module 606 may also be provided. The goal management module 606. The goal management module 606 may be used to generate goals for business owners based on the highest priority insights delivered. It may allow for collaboration between business owners, concierges, and advisors by managing access according to a business owner's preferences. The goal management module 606 may provide a set of granular steps to address challenges and may incorporate industry and business coaching concepts that are actionable. The goal management 606 may include different scenario planning and may generate projections based on the potential impact of performing each prescribed step and the timing of completion of each prescribed step. In some implementations completion of action plans may be gamified and the impact on the business and the business scorecard may be visible. It is noted that the functionality provided by this module may be the same as the action module 335 (FIG. 3), or additional functionality may be provided here.

A library and content module 608 may be provided. The library and content module 608 may be provided to include information useful to a business owner including to fill in any gaps in their knowledge which is useful in understanding insights or implementation of actions, determination of goals or otherwise. It is contemplated that in some instances, content mag be AI generated based on insights, underlying data, information about a business, or information about a business owner and their preferences to convey the most relevant data to the business owner in the most efficient manner possible.

A forum module 610 is also shown. A forum may serve as an expression of a community where business owners and team members working through insights may ask questions of others working the same or similar insights and network with other business owners to share their understanding of insights, action plans, and other feedback on their process. This also provides an opportunity for business owners to interact with others at various stages in working the same insights. It also provides an opportunity for advisors and concierges to better understand concerns and feedback from business owners and team members.

A business scorecard module 612 is shown which may be the same as scorecard module 337 (FIG. 3). The business score card module 612 may receive data from various category modules in order to provide visualization of financials, business processes, customers and organizational capacity against goals, set alerts for thresholds that are met or missed, provide advisors and concierges with a view of business scorecard information, or otherwise provide functionality related to showing feedback on progress made or quantify key indicators associated with different insights.

An onboarding module 614 is also shown, the onboarding process for a customer provides the path of least friction in creating an account and experiencing the platform. This may include obtaining necessary information in the least obtrusive and the least time-consuming manner such as by pre-filling information for a business owner from connected data sources.

A subscription management module 616 is also shown. The subscription management module 616 may be used to manage subscriptions services associated with the core services provided through the platform or additional or optional services made available through the platform.

A consultant module 618 is also shown. The consultant module 618 provides functionality related to consultants or advisers. This may include scheduling initial consultations with consultants and providing information in advance of the meeting or sharing insights or analysis with consultants. It is contemplated that an initial meeting may be free to a business owner and if the business owner engages the consultant for additional services that these services may be paid through the platform and the consultant may be provided with access to relevant data through the platform. It is also contemplated that consultants may have their own console or dashboard, particularly where they are working with multiple business owners and additional information may be made available to consultants.

A concierge module 620 is also shown. The concierge module 620 allows a concierge to monitor engagement of customers and potential customers including business owners, advisors, and strategic partners.

A partner module 622 is also shown. The partner module 622 allows a strategic partner such as one that provides products or services to manage their interaction with the platform including referrals, monitor engagement, maintain their own content, and other functionality. The partner module 622 may include their own console or dashboard.

Although various modules are shown in FIG. 16, it is to be understood that additional modules may be present. It is also to be understood that described functionality may be divided in alternative manners amongst the modules and/or additional modules so that more or fewer modules may be used depending upon the desired functionality and interactivity in a particular implementation or environment.

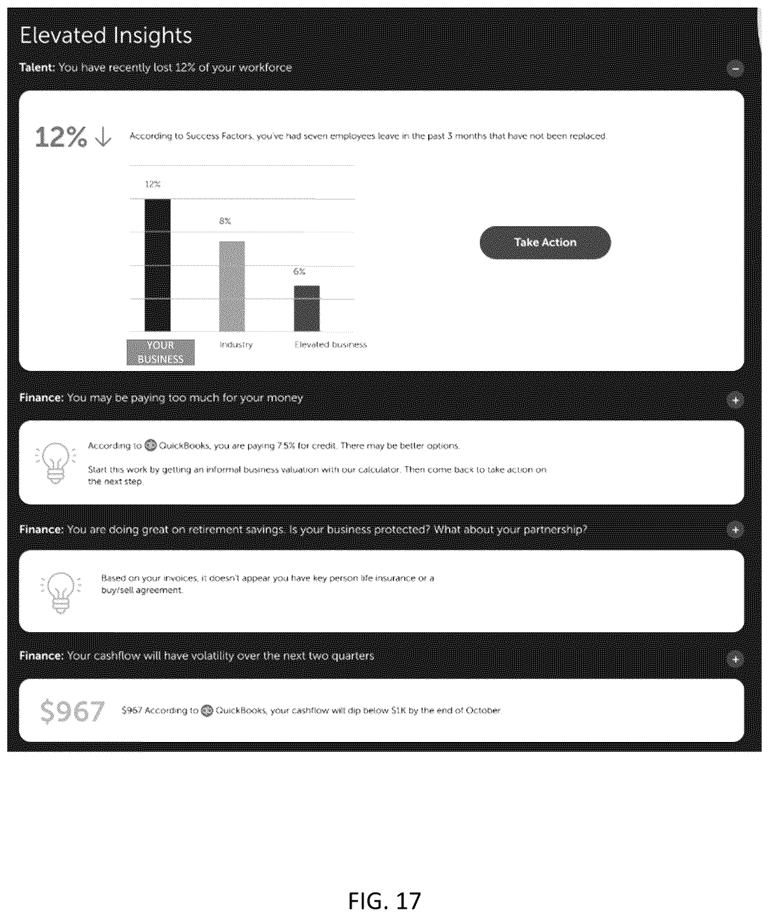

As previously explained throughout, different visualizations may be used to convey information to users. One example of a graphical user interface showing insights is provided in FIG. 17. Note that the insights have been prioritized such that only the top four insights are presented on this example. In addition, a solution path or path forward is provided where appropriate. Also where available, benchmarking data is provided, in this instance visualized in the form of a bar graph. In addition, a call to action is provided for the first insight. It is to be understood that more or fewer insights may be provided, more or fewer benchmarks may be provided, and there may be additional calls to action depending upon the insights. Of particular interest here is that very complex and extensive data has been analyzed in order to provide insights, to prioritize them, and to present them in a clearly understandable manner along with a path forwards.

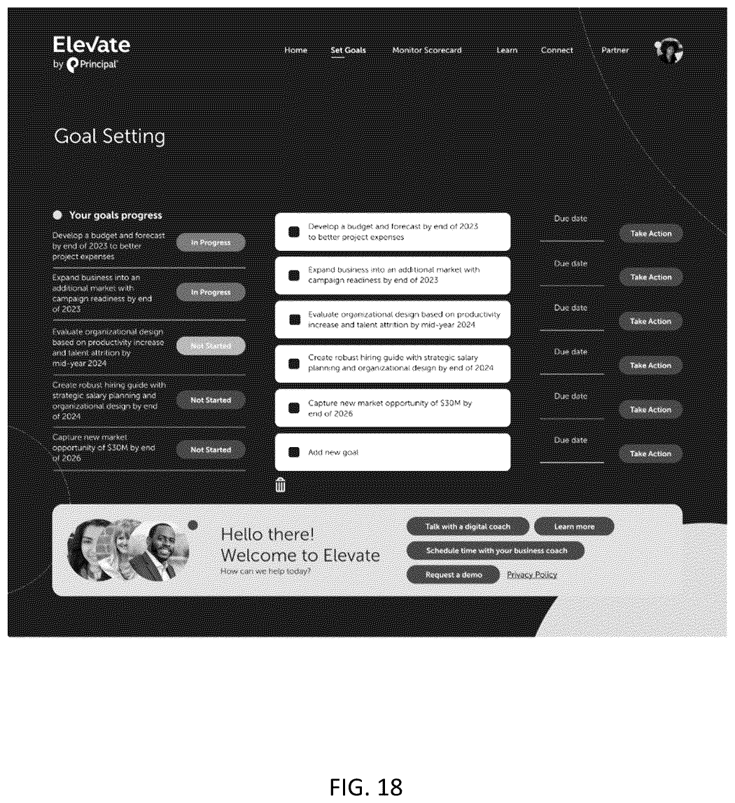

FIG. 18 is another example of a screen display or graphical user interface which assists a user in goal setting or tracking. These goals may also be considered action items. Based on the insights and their prioritization, action items may be generated by the system and/or action items may be modified or added by a business owner or in consultation with an advisor or concierge. The goal tracking shows the goals and the status of the goals and allows a user to take action. Although various functionality is shown, it should be understood that this or alternative functionality may be provided in any number of different ways. Of particular interest here, is a simple and convenient method of tracking goals in a manner which encourages a business owner to take action along a solutions path to progress towards goal completion.

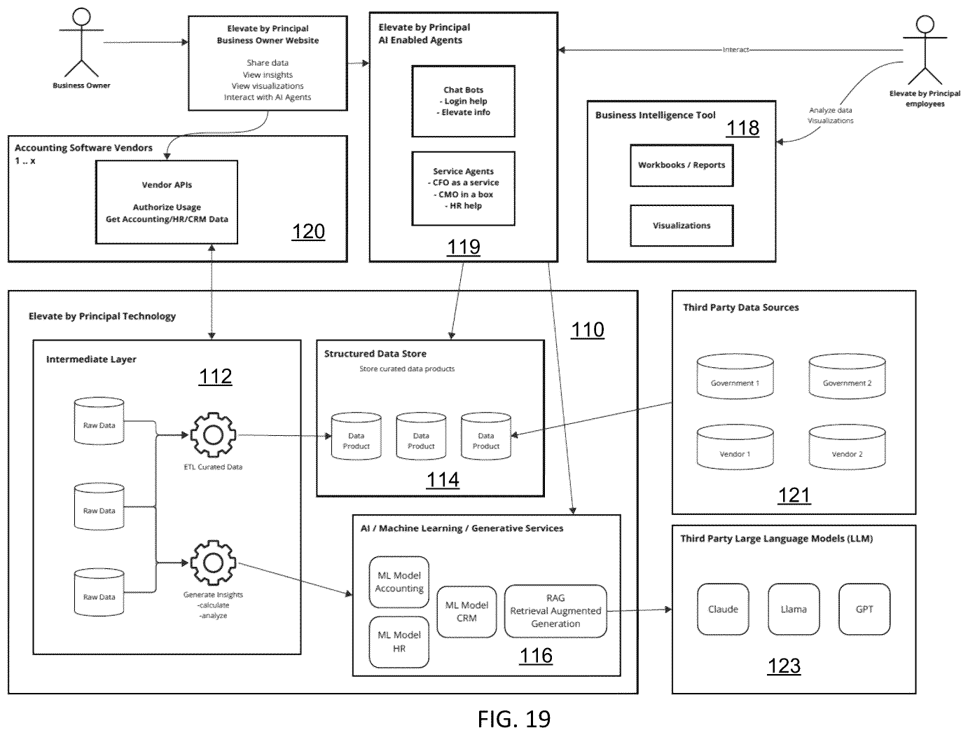

FIG. 19 further illustrates a system or platform for providing machine generated insights. The system or platform shown is one implementation as may be used in a particular use case. However, it is to be understood that what is shown is merely representative and numerous other implementations and use cases are contemplated as discussed herein. The system includes a platform 110 which may include one or more computing systems or devices, and which may be used to provide insights or other aspects of the system. The platform 110 includes an intermediate layer 112 where data is collected from one or more sources and integrated to form an ETL curated data set which may be stored in a memory 114 which may be a collection of data stores. The intermediate layer 112 may also communicate with one or more AI, machine learning, or generative AI models 116 to generate insights. For example, the AI models may include a machine learning model for accounting, a machine learning model for human resources, a machine learning model for client relationship management. Retrieval Augmented Generated (RAG) may also be provided as well as other tools for use by the models. In addition any number of different third party Large Language Models (LLMs) may be used including commercially available models such as Claude, Llama, GPT models, or others.

The system also allows for data to be obtained from data or service providers 120 such as through appropriate APIs, reports, or otherwise. A business intelligence tool 118 is also shown. The business intelligence tool 118 may be used to provide workbooks, reports, and visualizations such that insights or data in support of insights or action items based on insights may be delivered to a user such as a business owner.

Third party data sources 121 are also shown. The third party data sources may be associated with government data sources or commercial data sources from any number of different vendors.

AI enabled agents 119 are also shown. This may include agents such as chat bots which assist with login help or other information. The AI enabled agents 119 may also include service agents. The service agents may perform various functions, and each may have separate instructions and knowledge for performing the particular functions. In some examples, the instructions and knowledge may be based on a particular persona. For example, a service agent may act as a Chief Financial Officer (CFO), a Chief Marketing Officer (CMO), or a Human Resources (HR) Officer. In some examples, a user may converse with a service agent or a group of service agents in a multi-agent environment in order to identify insights, understand the relationships between different issues or insights, or to better understand information.

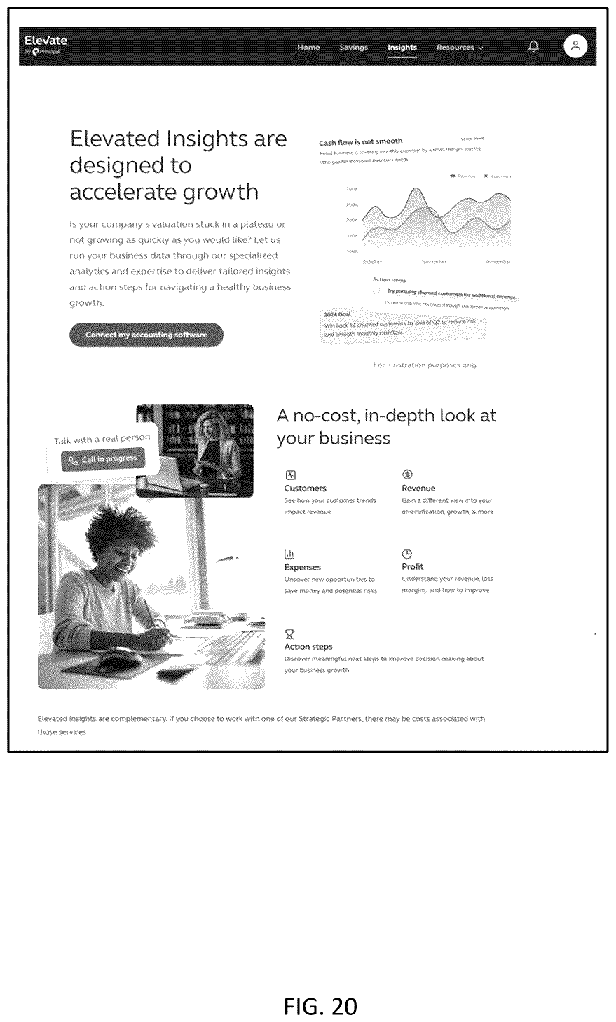

FIG. 20 through FIG. 32B provides examples of different screenshots as may be generated and viewed by a user. It should be understood this is merely one example of how insights once identified and prioritized may be presented. Instead of presenting as a part of a web interface, it is contemplated that presentation of this material may also be presented through generating a slide deck presentation containing the insights, generating audio and/or video containing the insights, generating a document or report containing the insight or otherwise.

FIG. 20 illustrates an example of a home page or landing page. The landing page may be configured to easily convey the purpose and capabilities of the system to the intended audience.

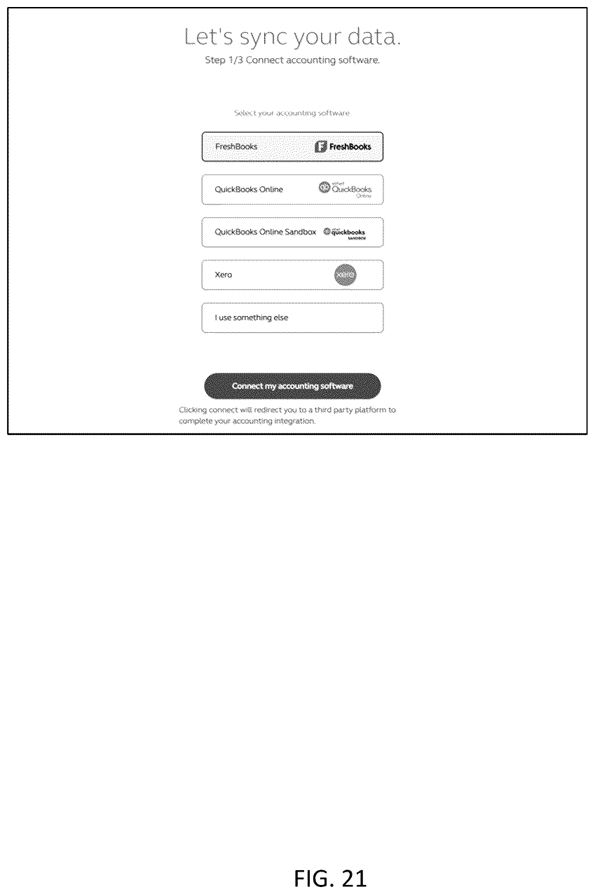

FIG. 21 illustrates an example of a user interface which allows for synchronization of data between a user's accounting system(s) and the system or platform. It is to be understood that any number of different accounting systems may be used to acquire data. Moreover, the user interface allows a user to select an accounting system with which to initiate a connection. Where the accounting system has an API, data from the accounting system may be accessed. For example, the API may be a REST API with OAuth authentication. In some instances a unified API may be available from a partner integration service to access multiple accounting systems. In addition, a data synchronization or data sync may be implemented using webhooks to provide real-time updates. Examples of accounting systems include, without limitation, FreshBooks, QuickBooks online, and Xero. It is also contemplated that a user may be able to provide information from accounting systems via file upload or otherwise.

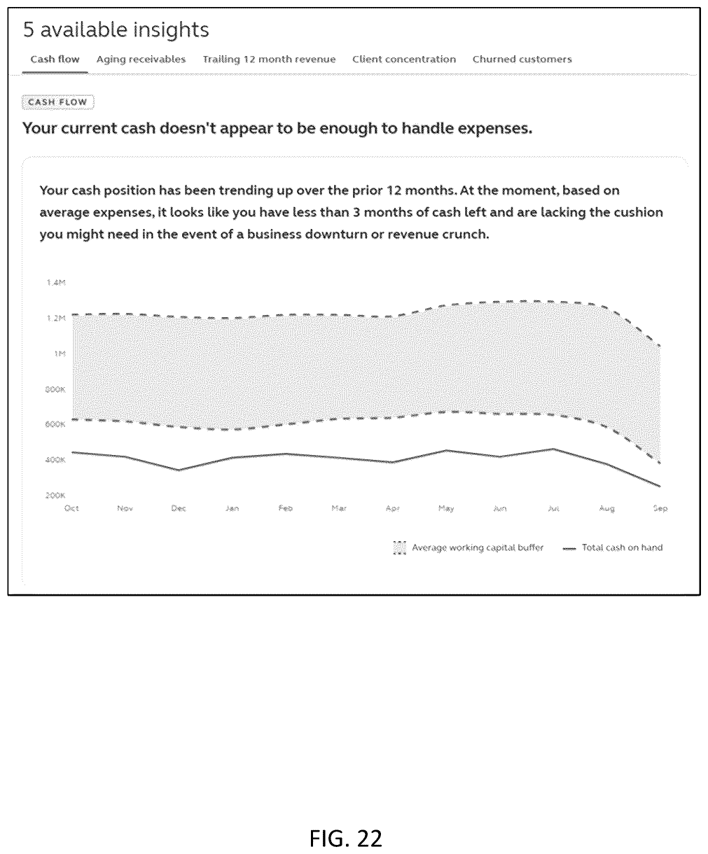

FIG. 22 is a screen display for presenting insights to a user with cash flow insights being shown. Note that various types of insights may be provided. For example, five categories of insights may be provided with a top insight for each category. The five categories of insights may be a subset of a much larger set of categories. The insight provided for each category may be a subset of a much larger set of insights for each particular category. However, as previously explained, the insights may be prioritized so that only the most important insights are provided. Moreover, the manner in which the top insights may be presented may also be ordered such that the most important insight is shown first.

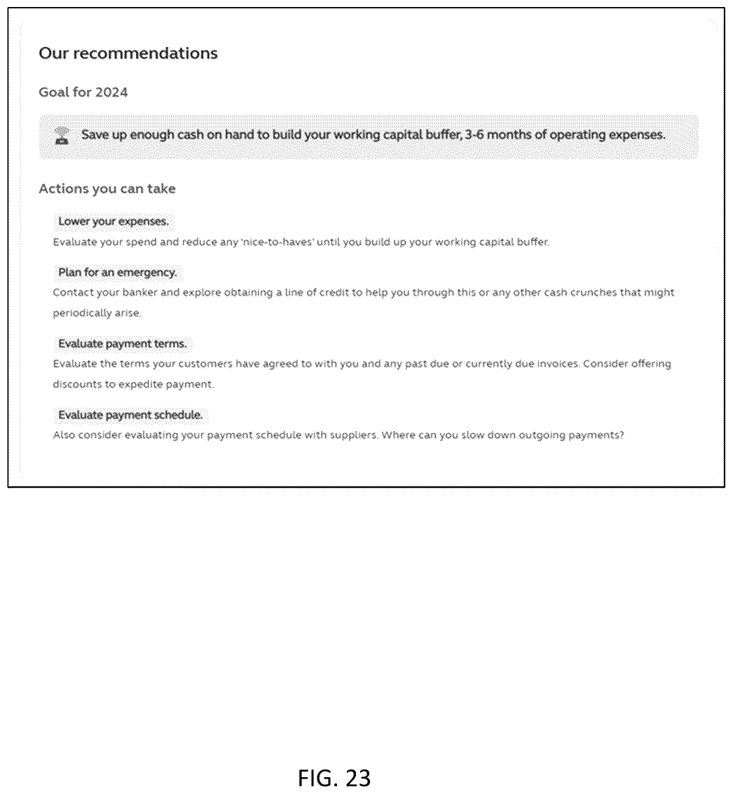

FIG. 23 is a screen display indicating recommendations for cash flow based on the cash flow insights in the form of a goal based on the insight and specific actions which may be taken to achieve the goal. Preferably, a plurality of different actions are provided such that a business need not take every action but may select one or more actions which may most effectively or most easily allow the business to accomplish the goal.

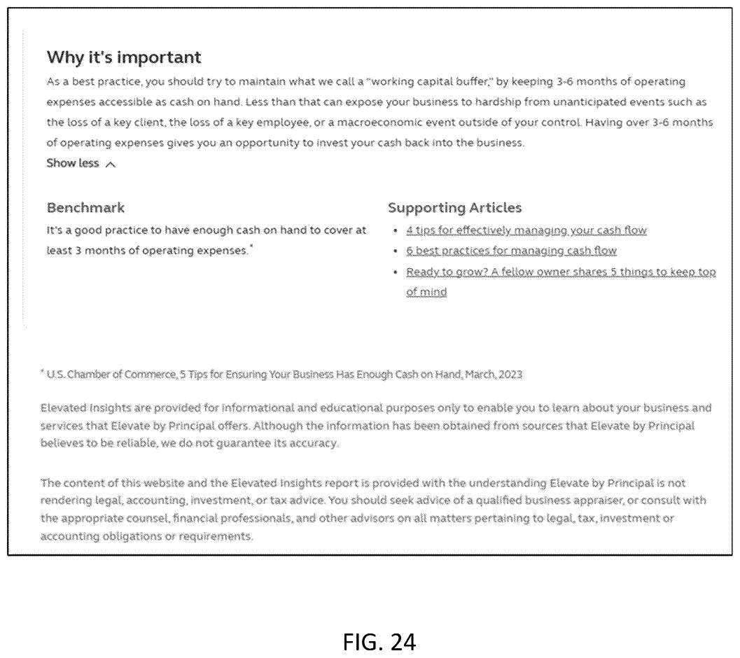

FIG. 24 is a screen display illustrating additional information about the cash flow insight as well as a benchmark and supporting resources. The benchmark provides a specific comparison, preferably quantitative in nature to assist the user in understanding how their metrics compare to other businesses or to recommended best practices. Supporting resources may include links to articles or other information which will assist a user in learning more about the insight.

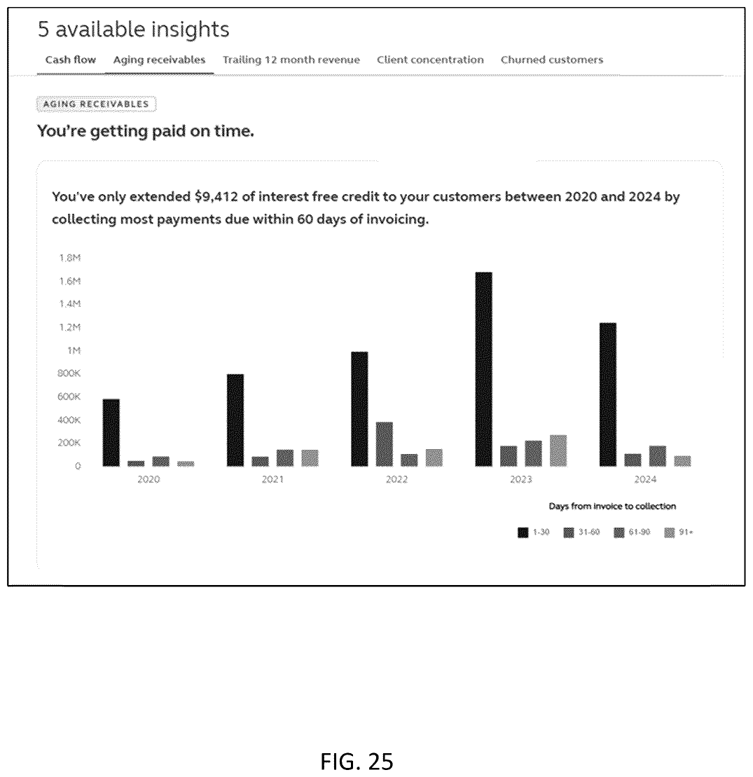

FIG. 25 is a screen display illustrating an aging receivables insight. Here a graph is shown for each year and indicates the days from invoice to collection (1 to 30 days), (31-60 days), (61− to 90 days), (91+ days). Here the insight relates to an amount of money which has been extended as interest free credit during a time period extending to 60 days or under. Based on the analysis, the insight is, “You're getting paid on time”.

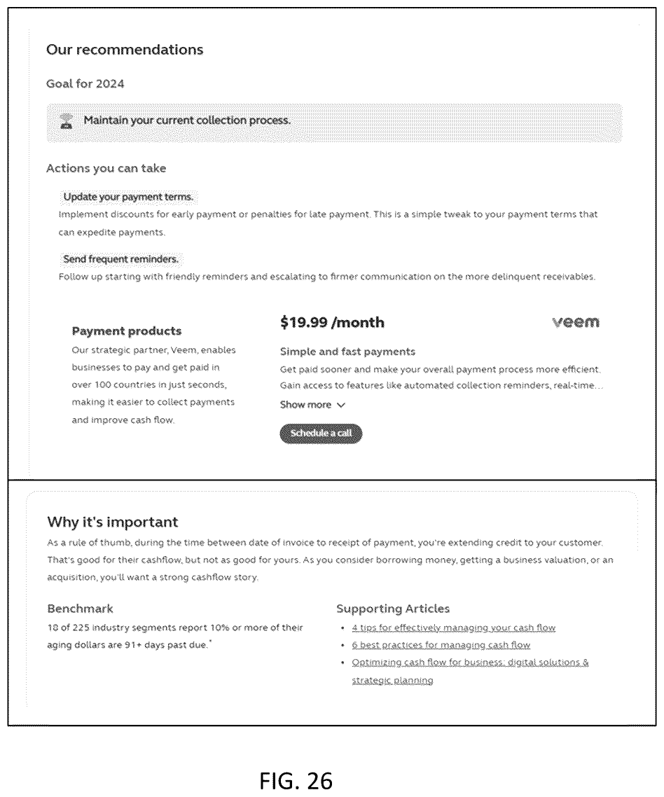

FIG. 26 is a screen display indicating recommendations and additional information for the aging receivable screenshot. In particular, here the goal is to “Maintain your current collection process”. In addition, actions are still provided to assist in working towards the goal. Here the actions include, “Update your payment terms” and “Send frequent requirements. In addition, various third party products are shown as resources which a business may use to meet the goal. Additional information regarding why the insight is important including quantitative benchmark information. Additional resources in the form of articles are also provided through links.

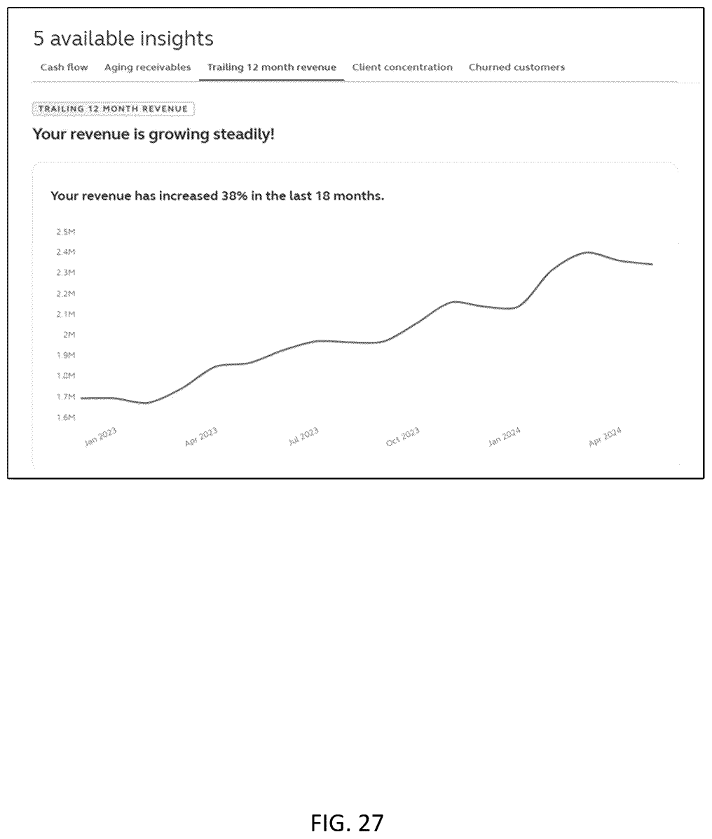

FIG. 27 is a screen display indicating a trailing 12 month revenue insight. Here, the insight is, “Your revenue is growing steadily”. A graph is shown showing revenue.

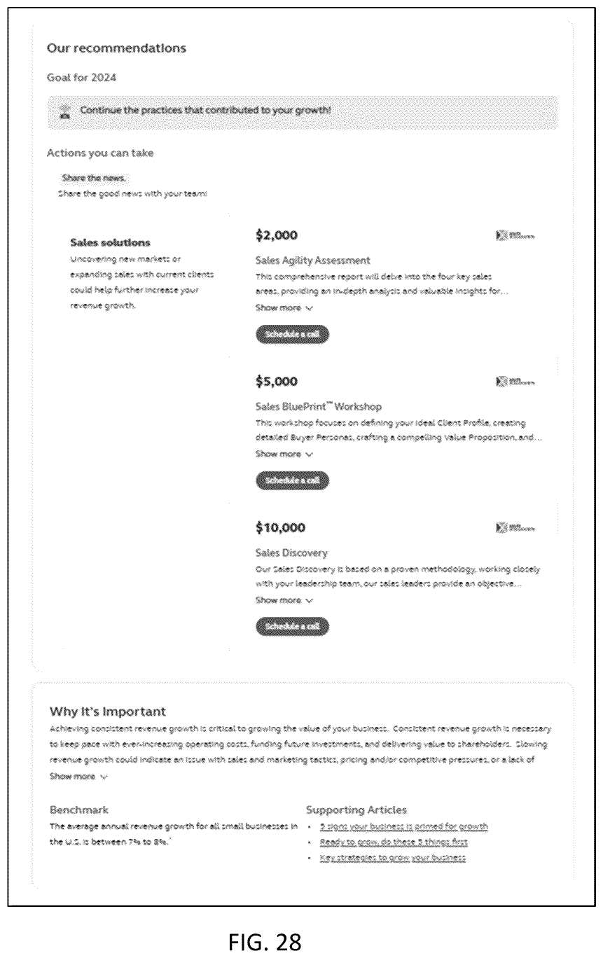

FIG. 28 is a screen display indicating recommendations and additional information for the trailing 12 month revenue insight. The recommendation here is to “Continue the practices that contributed to your growth”. An action item, “Share the news” is shown. In addition, various solutions from third party providers are shown. An explanation of why the insight is important is provided. In addition a benchmark is provided, which is preferably quantitative in nature. Links to various articles are also provided.

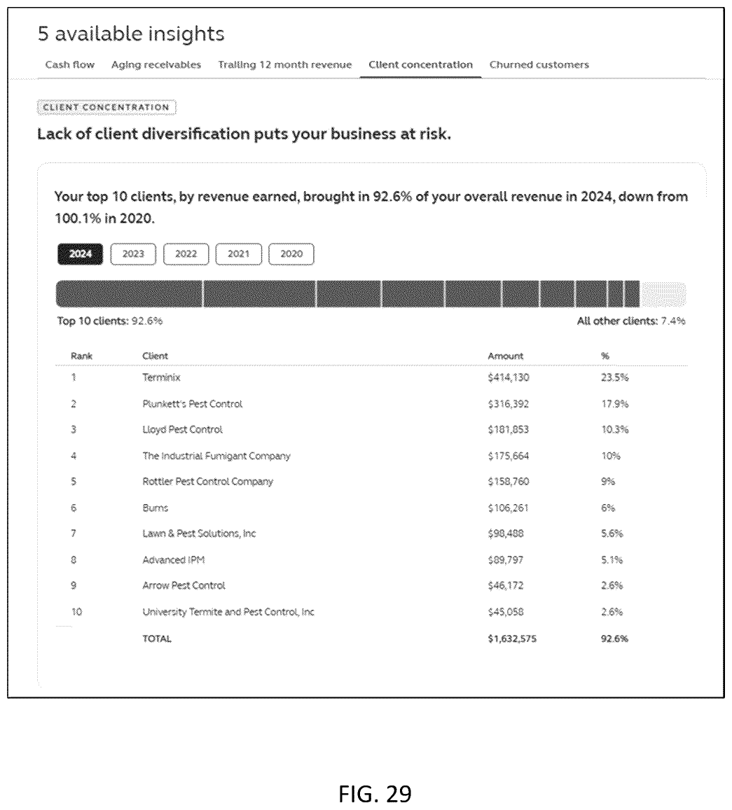

FIG. 29 is a screen display indicating a client concentration insight. Here, the insight is “Lack of client diversification puts your business at risk”. A chart and table are shown to assist in conveying the amount of client diversification.

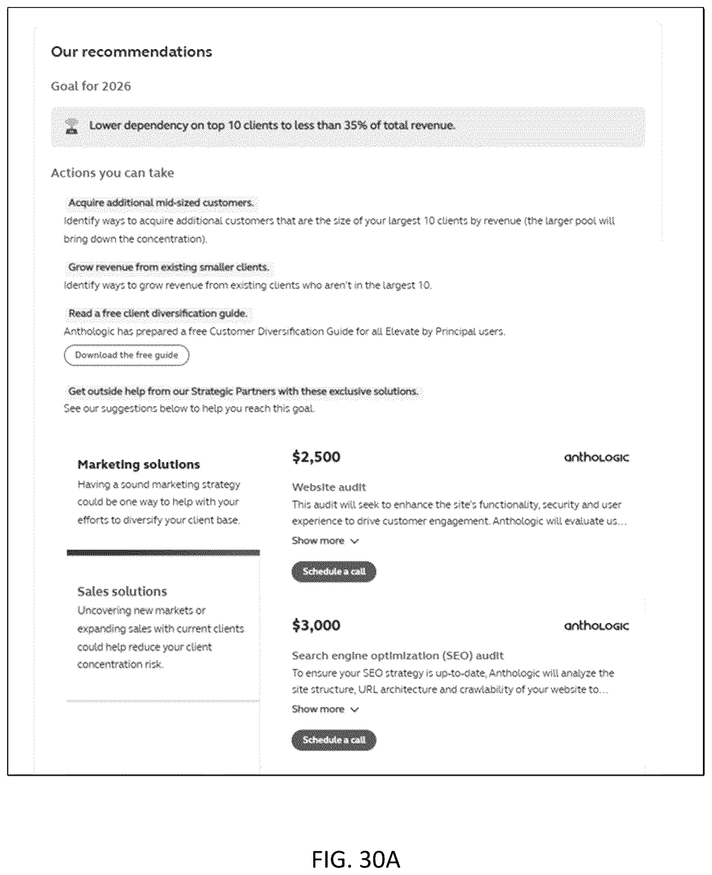

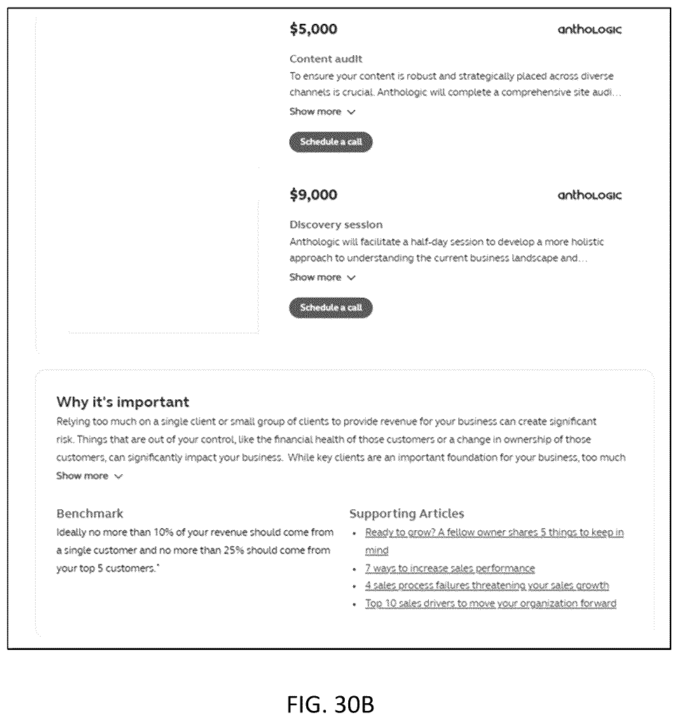

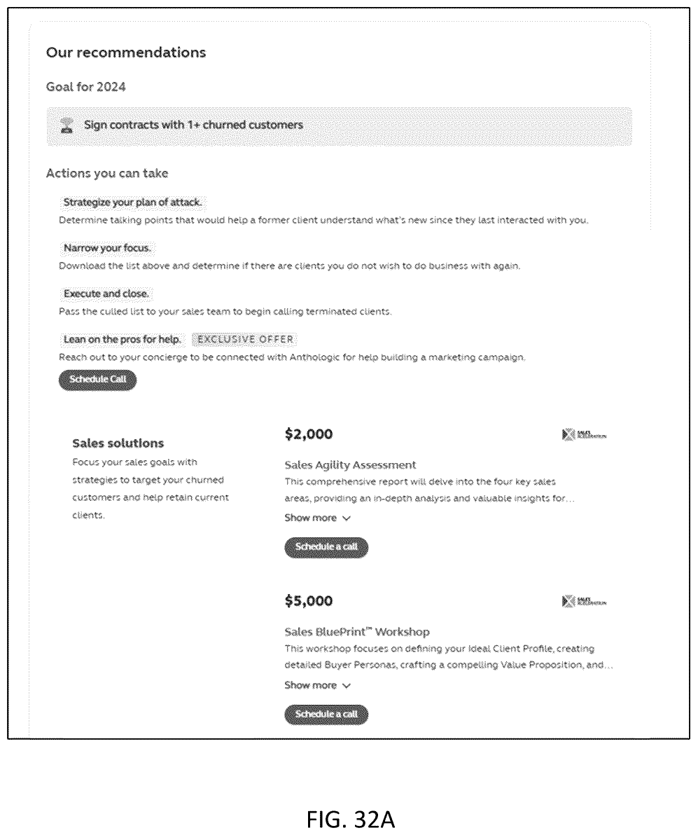

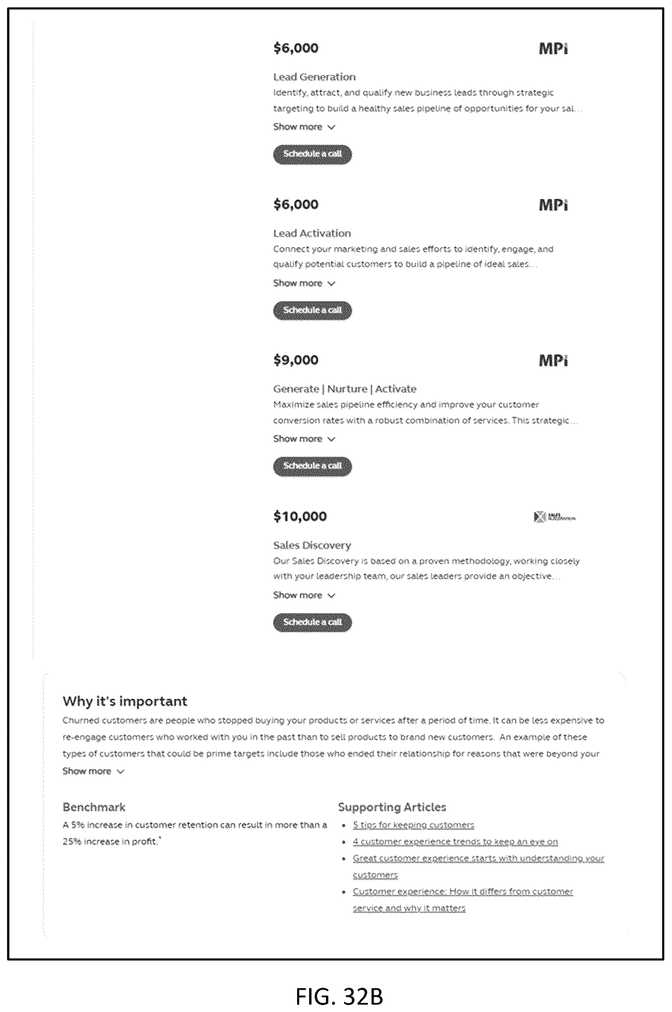

FIG. 30A and FIG. 30B represent a screen display indicating recommendations and additional information for the client concentration insight. This includes a goal to “lower dependency on top 10 clients to less than 35% of revenue”. It further includes a list of various actions that can be taken including, “acquire additional mid-sized clients”, grow revenue from existing smaller clients, and “read a free client diversification guide”. Resources for marketing solutions and sales solutions are also provided. FIG. 32B further provides an explanation of why the insight is important and links to additional resources.

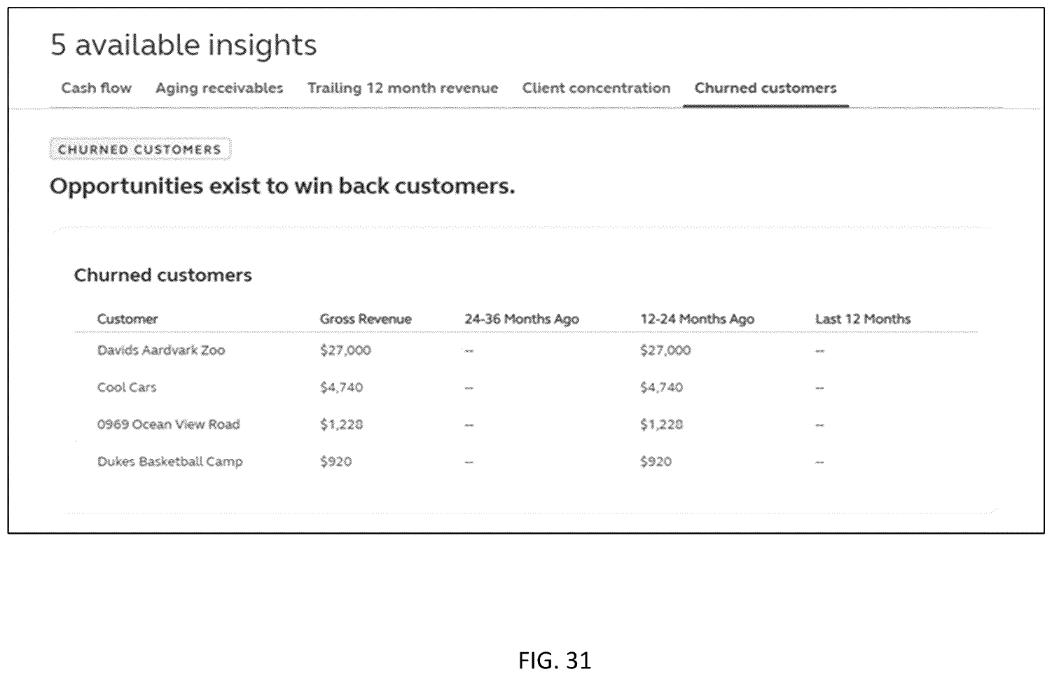

FIG. 31 is a screen display indicating a churned customers insight. In particular here, the insight is “Opportunities exist to win back customers”. A table shows the churned customers and the gross revenue for the churned customers and the revenue associated with different time periods.

FIG. 32A and FIG. 32B represent a screen display indicating recommendations and additional information for the churned customer insight.

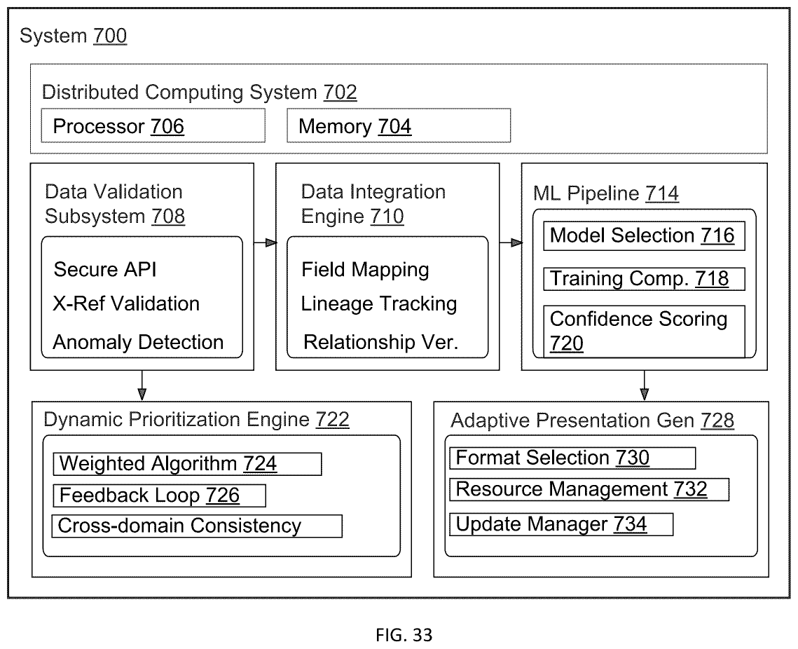

FIG. 33 illustrates another implementation of a system 700 for generating validated machine learning insights. The system 700 includes a distributed computing system 702, which may be implemented across multiple servers or cloud computing resources to provide scalable processing capabilities. A computer readable memory 704 provides storage for data and instructions, while at least one processor 706 executes instructions to implement various subsystems and engines described herein.

A data validation subsystem 708 serves as the front-end for data ingestion and validation. The subsystem 708 establishes secure API connections with accounting platforms as described in relation to FIG. 14, but extends this functionality by implementing standardized protocols for data retrieval and validation. The subsystem 708 validates data consistency by verifying cross-reference integrity between related accounting entries, building upon the accounting relationship principles previously described. The subsystem 708 further implements accounting relationship rules to detect and correct data anomalies, such as identifying and resolving discrepancies in double-entry accounting relationships.

A data integration engine 710 works in conjunction with the data validation subsystem 708 to create a standardized and validated dataset. The engine 710 extends the functionality of the intermediate layer described in FIG. 1 by implementing automated field mapping between heterogeneous data sources and a standardized data model. The engine 710 maintains detailed data lineage tracking throughout the integration process, recording each transformation and validation step. This tracking enables the system to generate an integrated dataset 712 with verified relationship integrity, which is stored with specialized indexing optimized for machine learning model access.

The system 700 implements a machine learning pipeline 714 that builds upon the AI models described in relation to FIG. 14. The pipeline 714 includes a model selection component 716 that analyzes data characteristics to select appropriate machine learning models for specific analysis tasks. A training component 718 incorporates accounting relationships as validation constraints during model training, ensuring that generated insights maintain consistency with fundamental accounting principles. The pipeline 714 generates entity insights with associated confidence scores 720 derived from the validation metrics maintained by the data validation subsystem 708, while maintaining traceable connections between insights and their source accounting data.

A dynamic prioritization engine 722 enhances the functionality of the prioritization module described in FIG. 3. The engine 722 evaluates insight reliability using source data validation metrics and calculates priority scores using a multi-factor weighted algorithm 724. The engine 722 implements a feedback loop 726 that adjusts prioritization weights based on computational results and maintains consistency between related insights across different business domains as previously described.

An adaptive presentation generator 728 builds upon the presentation module described in FIG. 3, implementing advanced visualization capabilities. The generator 728 includes a format selection component 730 that analyzes data characteristics to select optimal visualization formats. A resource management component 732 implements progressive data disclosure based on available system resources, while a real-time update manager 734 maintains visualization currency while optimizing computational efficiency. The generator 728 produces interactive visualizations with validation trace-back capabilities, allowing users to explore the relationship between insights and their underlying source data.

Although specific examples have been set forth herein, numerous options, variations, and alternatives are contemplated. For example, although neural networks, and more specifically convolutional neural networks are described in examples, it is contemplated that other types of deep learning may be performed instead, including, without limitation, recurrent neural networks, other types of neural networks, and other types of machine learning algorithms or techniques. The term “deep learning” should be understood to encompass these and other types of machine learning algorithms techniques whether known now or developed in the future. It is also to be understood, that the particular type of deep learning used may be dependent upon the analysis to be performed, the amount of data to be analyzed, the processing capability available, the amount of time allotted for processing, and/or other constraints which may be associated with a particular implementation and/or use.

The methods described herein may be incorporated into the software in the form of instructions stored on a non-transitory computer readable medium which may be used to perform analysis.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor such as one or more central processing units (CPUs) and/or one or more graphics processing units (GPUs)) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location. In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data”, “content”, “bits”, “values”, “elements”, “symbols”, “characters”, “terms”, “numbers”, “numerals”, or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. It is to be further understood, that aspects of different embodiments may be combined.

As used herein any reference to “model” means a framework or construct which allows a machine either through hardware or software or a combination thereof to generate an output based on the inputs. As used here in “AI model” means a model which is constructed or applied using one or more machine learning or other AI framework or constructs. As used herein “AI agent” refers to an implementation which uses an AI model configured to perform a task which involves interaction with other AI agents, data sources, or humans.

As used herein, the terms “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

The invention is not to be limited to the particular embodiments described herein. In particular, the invention contemplates numerous variations in segmentation. The foregoing description has been presented for purposes of illustration and description. It is not intended to be an exhaustive list or limit any of the invention to the precise forms disclosed. It is contemplated that other alternatives or exemplary aspects are considered included in the invention. The description is merely examples of embodiments, processes, or methods of the invention. It is understood that any other modifications, substitutions, and/or additions can be made, which are within the intended spirit and scope of the invention.

What is claimed is:

1. A system configured to extract, classify, and order entity insights, the system comprising:
a computing system;
a computer readable memory;
at least one processor having instruction configured for:
ingesting data into the system from at least one external application programming interface configured to retrieve data over a network;
integrating the data to form a cohesive data set using the at least one processor;
storing the cohesive data set into the computer readable memory;
processing the cohesive data set by the at least one processor using at least one machine learning model to generate a plurality of entity insights, each of the insights having at least one classification associated therewith;
ordering the plurality of the entity insights based on a machine generated prioritization; and
generating a presentation comprising the plurality of entity insights in human-readable form.

2. The system of claim 1 further comprising:
wherein the cohesive data set includes validated accounting data maintaining double-entry accounting relationships between accounts;
wherein integrating the data to form the cohesive data set comprises:
mapping data fields from different sources to a standardized data model,
validating cross-reference integrity between related accounting entries,
maintaining temporal dependencies between transactions, and
tracking data lineage from source systems through transformations;
wherein the cohesive data set maintains referential integrity between:
profit and loss statement entries,
balance sheet entries,
general ledger entries,
journal entries, and
transaction records; and
wherein the cohesive data set includes validation metrics indicating quality and completeness of data integration.

3. The system of claim 1 wherein the presentation is associated with a dashboard display.

4. The system of claim 1 wherein the presentation of the data comprises machine generated factual statements about the data.

5. The system of claim 1 wherein the presentation of the data comprises contextual information to aid in understanding implications of the plurality of entity insights.

6. The system of claim 1 wherein the presentation of the data further comprises an external benchmark to demonstrate entity standing.

7. The system of claim 1 wherein the presentation further comprises a machine generated strategic goal associated with at least on the plurality of entity insights.

8. The system of claim 1 further comprising identification of a forum for meeting with others who have received related machine generated strategic goals and wherein the presentation further comprises the identification of the forum.

9. The system of claim 1 wherein the at least one machine learning model comprises a plurality of machine learning models to generate the plurality of entity insights.

10. The system of claim 8 wherein the plurality of machine learning models includes at least one large language model.

11. The system of claim 1 wherein the at least one machine learning model comprises at least one generative pre-trained transformer.

12. The system of claim 1 wherein the at least one machine learning model comprises at least one deep learning model.

13. The system of claim 1 wherein the at least one machine learning model comprises at least one neural network.

14. A system for generating validated machine learning insights, the system comprising:
a distributed computing system;
a computer readable memory;
at least one processor having instructions configured to implement:
a data validation subsystem configured to:
ingest data into the system through secure API connections configured to retrieve accounting data over a network using standardized protocols,
validate data consistency by verifying cross-reference integrity between related accounting entries,
detect and correct data anomalies using accounting relationship rules;
a data integration engine configured to:
map heterogeneous data sources to a standardized data model using automated field mapping,
maintain data lineage tracking through an integration process,
generate an integrated dataset with verified relationship integrity,
store the integrated dataset with indexing optimized for machine learning model access;
a machine learning pipeline configured to:
select appropriate machine learning models based on data characteristics,
train models using accounting relationships as validation constraints,
generate entity insights with confidence scores derived from data validation metrics,
maintain traceable connections between insights and source accounting data;
a dynamic prioritization engine configured to:
evaluate insight reliability using source data validation metrics,
calculate insight priority scores using a multi-factor weighted algorithm,
adjust prioritization weights based on computational feedback,
maintain consistency between related insights across business domains; and
an adaptive presentation generator configured to:
select optimal visualization formats based on data characteristics,
implement progressive data disclosure based on system resources,
generate interactive visualizations.

15. The system of claim 14 further comprising a benchmark module configured to provide benchmarks associated with a business, an action module for determining actions to perform based on the insights, and a scorecard module for providing ongoing feedback related to the actions and the insights.

16. The system of claim 14 wherein each of the machine learning pipeline is configured to analyze data to generate insights comprises a plurality of AI agents.

17. The system of claim 14 wherein the machine learning pipeline implements a multi-agent artificial intelligence framework comprising: a data assessment agent configured to identify and validate data sources; data collection agents configured to retrieve and validate accounting data; domain-specific insight agents configured to analyze validated data within business domains; a cross-domain validation agent configured to verify consistency between domain-specific insights; a prioritization agent configured to rank insights based on validation metrics; and a presentation agent configured to generate validated visualizations.
